(19) United States
(12) Patent Application Publication
(10) Pub. No.: US 2022/0100874 A1
(43) Pub. Date: Mar. 31, 2022

(54) DATA LOSS PROTECTION ON SECONDARY DISPLAYS

(71) Applicant: Citrix Systems, Inc., Fort Lauderdale, FL (US)

(72) Inventor: Manbinder Pal Singh, Coral Springs, FL (US)

(21) Appl. No.: 17/031,986

(22) Filed: Sep. 25, 2020

(51) Int. Cl. G06F 21/60; G06F 21/62; G06F 40/109; G09G 5/02; G09G 5/26

(52) U.S. Cl. CPC G06F 21/604; G06F 21/6218; G09G 2354/00; G09G 5/02; G09G 5/26; G06F 40/109

(57) ABSTRACT

Techniques are disclosed for providing data loss protection of sensitive information during display on a secondary display separate from a display of a computing device. An example methodology implementing the techniques includes identifying sensitive information within content displayable with use of a display of a computing device and adding metadata to the sensitive information, the metadata to cause a change in an appearance of the content before display of that content on a secondary display, the secondary display being separate from the display of the computing device. The method also includes, responsive to a determination to display the content on the secondary display, modifying the content based on the added metadata so that sensitive information is hidden from view while the content is shown on the secondary display and providing on the secondary display the modified content so as to prevent the sensitive information from being viewable by users.

### BACKGROUND

Users commonly use computing devices to display content on secondary or auxiliary displays different than primary displays of the computing devices. For example, mobile devices with computing capability, such as laptops, 2-in-1 computers, convertible computers, tablet computers, and other similar devices, often support the use of a secondary display. Secondary displays may be larger than primary displays, making them better suited for certain tasks, such as displaying large documents and conducting group presentations.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one example embodiment provided to illustrate the broader concepts, systems, and techniques described herein, a method may include identifying sensitive information within content displayable with use of a display of a computing device and adding metadata to the sensitive information, the metadata to cause a change in an appearance of the content before display of that content on a secondary display, the secondary display being separate from the display of the computing device. The method may also include, responsive to a determination to display the content on the secondary display, modifying the content based on the added metadata so that sensitive information is hidden from view while the content is shown on the secondary display and providing on the secondary display the modified content so as to prevent the sensitive information from being viewable by users not authorized to view such sensitive information.

According to another illustrative embodiment provided to illustrate the broader concepts described herein, a system includes a memory and one or more processors in communication with the memory. The processor may be configured to identify sensitive information within content displayable with use of a display of a computing device and add metadata to the sensitive information, the metadata to cause a change in an appearance of the content before display of that content on a secondary display, the secondary display being separate from the display of the computing device. The processor may be also configured to, responsive to a determination to display the content on the secondary display, modify the content based on the added metadata so that sensitive information is hidden from view while the content is shown on the secondary display and provide on the secondary display the modified content so as to prevent the sensitive information from being viewable by users not authorized to view such sensitive information.

According to another illustrative embodiment provided to illustrate the broader concepts described herein, a method may include identifying sensitive information within content to be displayed on a display of a computing device and, responsive to a determination to display the content on a secondary display distinct from a display of the computing device, modifying the content so that sensitive information is hidden from view while the content is shown on the secondary display, displaying on the secondary display the modified content so as to prevent the sensitive information from being viewable, and providing a toggle control for enabling or disabling modifying of the content.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative network computing environment in which embodiments of the present disclosure may be implemented.

FIG. 2 is a block diagram illustrating selective components of an example computing device in which various aspects of the disclosure may be implemented, in accordance with an embodiment of the present disclosure.

FIG. 3 is a schematic block diagram of a cloud computing environment in which various aspects of the disclosure may be implemented.

FIG. 4A is a block diagram of an illustrative system in which resource management services may manage and streamline access by clients to resource feeds (via one or more gateway services) and/or software-as-a-service (SaaS) applications.

FIG. 4B is a block diagram showing an illustrative implementation of the system shown in FIG. 4A in which various resource management services as well as a gateway service are located within a cloud computing environment.

FIG. 4C is a block diagram similar to FIG. 4B but in which the available resources are represented by a single box labeled “systems of record,” and further in which several different services are included among the resource management services.

FIG. 5 is a block diagram of an illustrative enterprise mobility management system, in accordance with an embodiment of the present disclosure.

FIG. 6 is a block diagram of an illustrative enterprise computing device management system, in accordance with an embodiment of the present disclosure.

FIG. 7 is a diagram illustrating an example environment in which data loss protection may be implemented, in accordance with an embodiment of the present disclosure.

FIG. 8 is a flow diagram of an example process for applying data loss protection during display on a secondary display, in accordance with an embodiment of the present disclosure.

FIG. 9 is a flow diagram of an example process for applying data loss protection during display on a secondary display, in accordance with another embodiment of the present disclosure.

FIG. 10 is a flow diagram of an example process for applying data loss protection based on a toggle control, in accordance with an embodiment of the present disclosure.

### DETAILED DESCRIPTION

Computing devices, such as mobile devices, can be utilized for a wide range of operations. For certain of the operations a connection to a secondary or external display (or “monitor”) may be beneficial because this may allow the use of a larger screen as compared to the relatively smaller screen of a display of the computing device. For example, a user attending a meeting in a meeting room may connect his or her laptop computer to a secondary display in the meeting room, such as a large-format display, and cast or mirror the contents being displayed on the laptop's display to the larger screen of the secondary display. However, casting to the larger secondary display will cause any sensitive information that may be being displayed on the laptop's display to also be displayed on the larger screen of the secondary display and be viewable by the meeting attendees and others who may be present in the meeting room. Unfortunately, the display of the sensitive information on the secondary display may be unintended or unintentional. Further, there is also a risk that such displayed sensitive information may be leaked or otherwise compromised.

Concepts, devices, systems, and techniques are disclosed for protection of sensitive information during display of the sensitive information based on a context of the display on which the sensitive information is being displayed. In embodiments, protection of sensitive information is achieved by determining whether sensitive information is being displayed on a secondary display separate or otherwise distinct from a display of a computing device. If a determination is made that the sensitive information is to be displayed on the secondary display, then data loss protection may be enabled. For example, in such cases, the sensitive information may be displayed in modified or obfuscated form. If the content does not contain sensitive information or the content not being displayed on the secondary display (the content, including any sensitive information contained in the content, is to be displayed only on the computing device's display), then data loss protection is not enabled. In such cases, the sensitive information may be displayed in its original, not obfuscated form (i.e., “as-is”).

In an embodiment, a toggle control may be provided with the display of the sensitive information on the secondary display. The toggle control may be configured to enable or not enable (disable) protection of sensitive information when the sensitive information is being displayed on the secondary display. In one such embodiment, the toggle control may be provided as a control element within or as part of an application window, such as a browser window, showing the sensitive information. Thus, the toggle control enables a user to turn ON or turn OFF the protection of sensitive information during display on the secondary display. The techniques disclosed herein reduce or effectively eliminate the potential for data leakage or loss caused by the display of sensitive information on secondary displays separate from the display of the computing device. These and other advantages, configurations, modifications, and embodiments will be apparent in light of this disclosure.

For example, and according to an embodiment, a user may be running application software (or more simply an “application”) on a computing device to access and/or interact with content, which may contain (include) one or more items (or elements) of sensitive information. Such an application running on the computing device may be programmed or otherwise configured to determine whether the content being accessed includes sensitive information. If it is determined that the content does not include sensitive information, the application can display or cause the display of the content in its original form without data loss protection. In this case, the display of the content may be on a display of the computing device and/or a secondary display separate from the display of the computing device. Display of the content in original form on the display allows viewing of the content by other users (e.g., users other than the user of the computing device).

Continuing the above example, if it is determined that the content includes sensitive information, the application can determine whether the content is to be displayed on a secondary display. For example, the application may launch on the primary display of the computing device and display the contents within an application window on the computing device's display. Subsequent to the launch of the application, the user may click and drag the application window from this display to the secondary display, causing the contents to be displayed on the secondary display. In some cases, the application may launch on the secondary display, and the user may click and drag the application window from the secondary display to the computing device's display or another secondary display. In any case, if it is determined that the content is to not be displayed on the secondary display, the application can display or cause the display of the content in its original form on the computing device's display without data loss protection.

Otherwise, if it is determined that the content is to be displayed on the secondary display, the application can enable protection of the sensitive information in the content. Enabling data loss protection may include modifying the content so that the sensitive information in the content is hidden from view while the content is shown on the secondary display. The application can then display or cause the display of the content with data loss protection (the modified content). Display of the content with data loss protection on the secondary display prevents viewing of the sensitive information in the displayed content.

In some embodiments, the application can provide a toggle control with the display of the content containing sensitive information on the secondary display. The toggle control may be configured to enable or not enable (disable) protection of sensitive information in the content being shown on the secondary display. In one such embodiment, the application can provide the toggle control as a control element within or as part of an application window showing the content containing the sensitive information. So, in the case where data loss protection is enabled and the sensitive information in the content is hidden from view, the user can use the toggle control to disable the data loss protection to cause the content to be displayed in its original form on the secondary display, in which case the sensitive information in the content is viewable while the content is shown on the secondary display. Alternatively, in the case where data loss protection is disabled and the sensitive information in the content is viewable, the user can use the toggle control to enable the data loss protection to cause the content to be displayed in modified from on the secondary display, in which case the sensitive information in the content is hidden from view while the content is shown on the secondary display.

As used herein, the term “sensitive information”, or “sensitive content”, or “confidential information”, or “confidential content” includes any information or content that is either legally confidential or identified by an individual/organization as being only intended to be seen/viewed by the user themselves, or intended to be seen/viewed by any one or more other persons authorized by this user. Other terms may also be used to refer to information or content that is either legally confidential/sensitive or identified by an individual/organization as being only for the eyes of the user themselves, or any one or more other persons authorized by this user. Non-limiting examples of sensitive information include any data that could potentially be used to identify a particular individual (e.g., a full name, Social Security number, driver's license number, bank account number, passport number, and email address), financial information regarding an individual/organization, information deemed confidential by the individual/organization (e.g., contracts, sales quotes, customer contact information, phone numbers, personal information about employees, and employee compensation information), and information classified by a governing authority as being confidential.

“Secondary display” or “auxiliary display” means a display that is not a primary display of a computing device, such as a display attached to a mobile device or a display attached to or otherwise integrated within a laptop computer. The secondary display may be an apparatus including a display screen that is connectable with or otherwise not integrated into the computing device display to provide another display for the computing device separate and distinct from the display of the computing device.

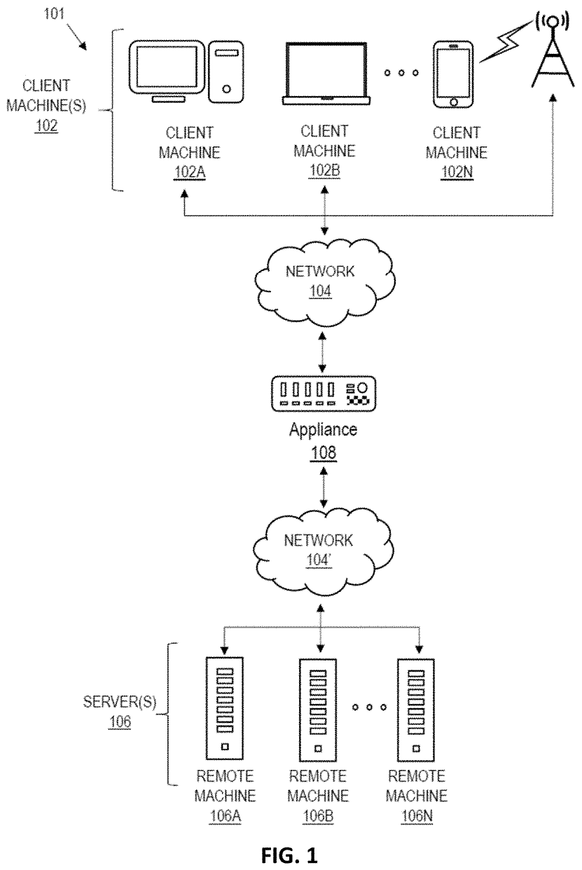

Referring now to FIG. 1, shown is an illustrative network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

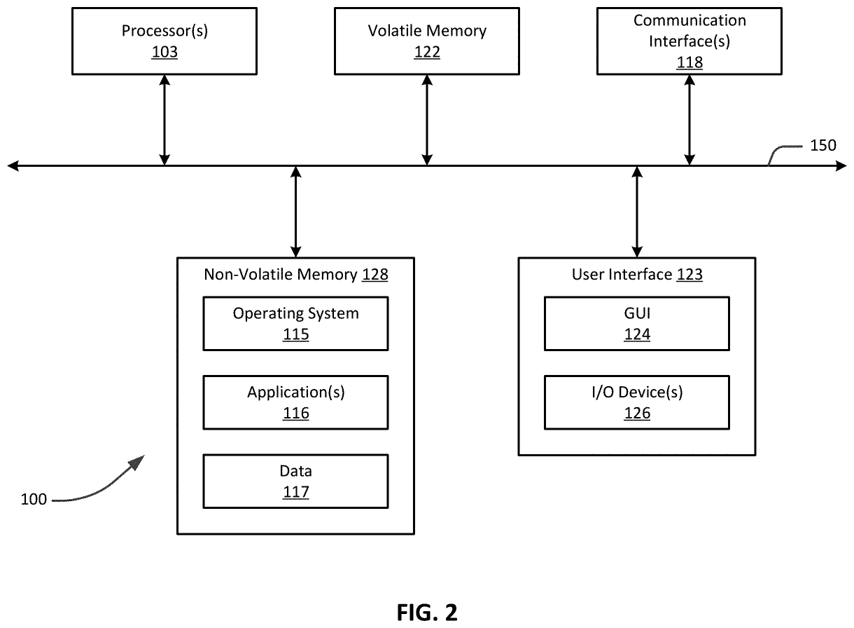

FIG. 2 is a block diagram illustrating selective components of an illustrative computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an illustrative client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

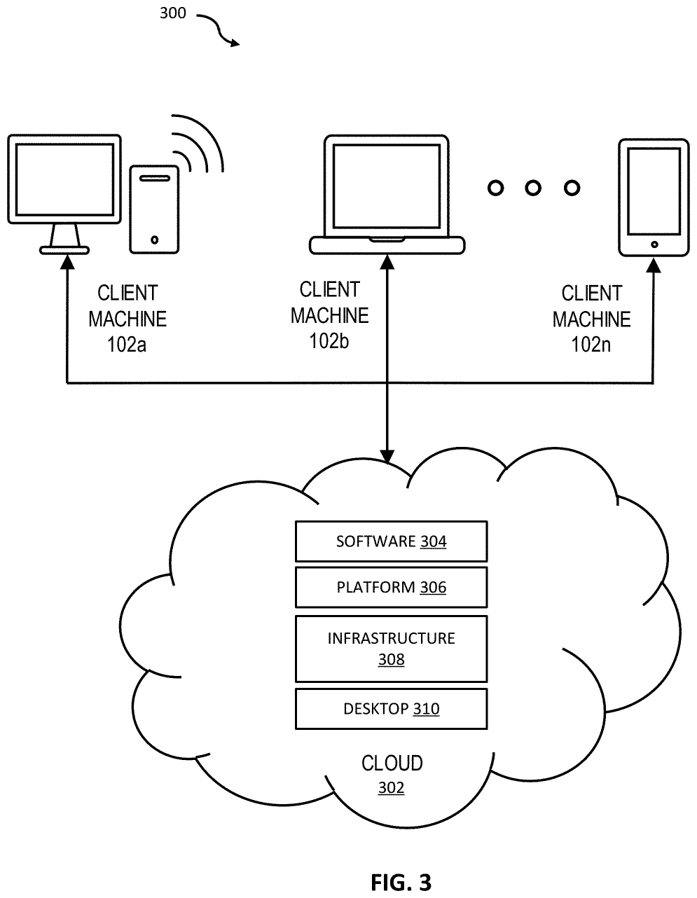

Referring to FIG. 3, a cloud computing environment 300 is depicted, which may also be referred to as a cloud environment, cloud computing or cloud network. Cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more clients 102a-102n (such as those described above) are in communication with a cloud network 302. Cloud network 302 may include back-end platforms, e.g., servers, storage, server farms or data centers. The users or clients 102a-102n can correspond to a single organization/tenant or multiple organizations/tenants. More particularly, in one example implementation cloud computing environment 300 may provide a private cloud serving a single organization (e.g., enterprise cloud). In another example, cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, cloud computing environment 300 may provide a hybrid cloud that is a combination of a public cloud and a private cloud. Public clouds may include public servers that are maintained by third parties to clients 102a-102n or the enterprise/tenant. The servers may be located off-site in remote geographical locations or otherwise.

Cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 300 can provide an elasticity to dynamically scale out or scale in response to different demands from one or more clients 102. In some embodiments, cloud computing environment 300 can include or provide monitoring services to monitor, control and/or generate reports corresponding to the provided shared services and resources.

In some embodiments, cloud computing environment 300 may provide cloud-based delivery of different types of cloud computing services, such as Software as a Service (SaaS) 304, Platform as a Service (PaaS) 306, Infrastructure as a Service (IaaS) 308, and Desktop as a Service (DaaS) 310, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

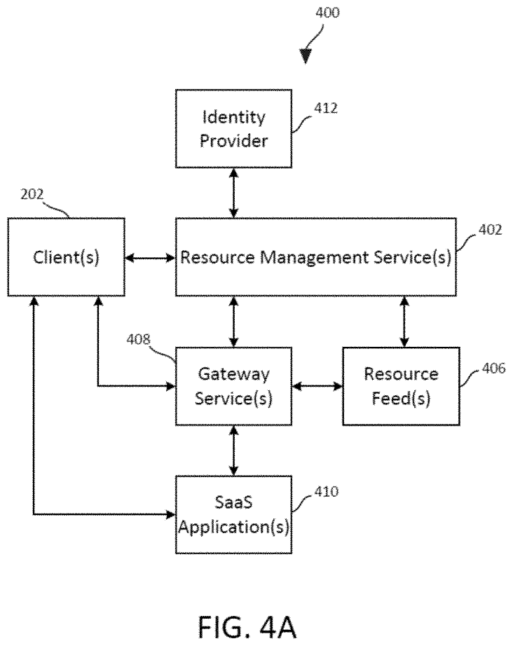

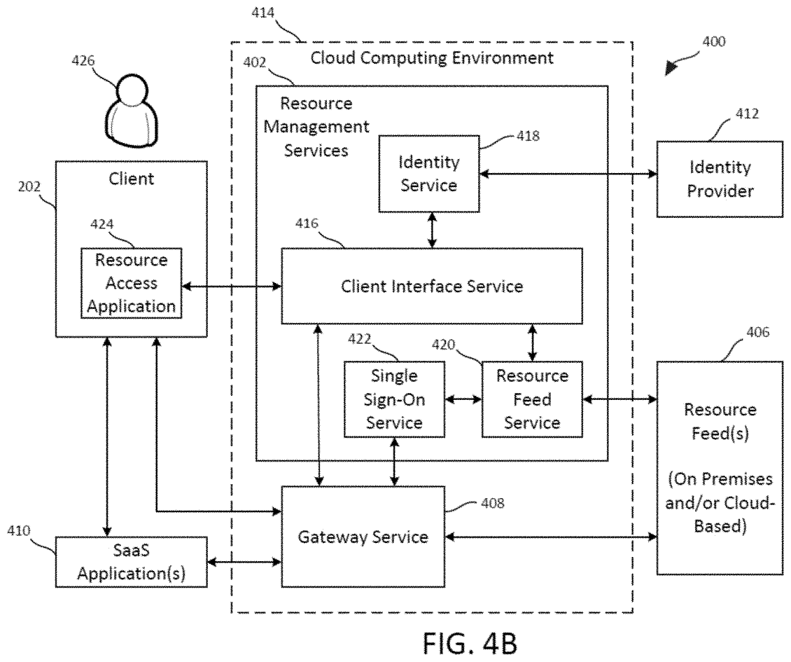

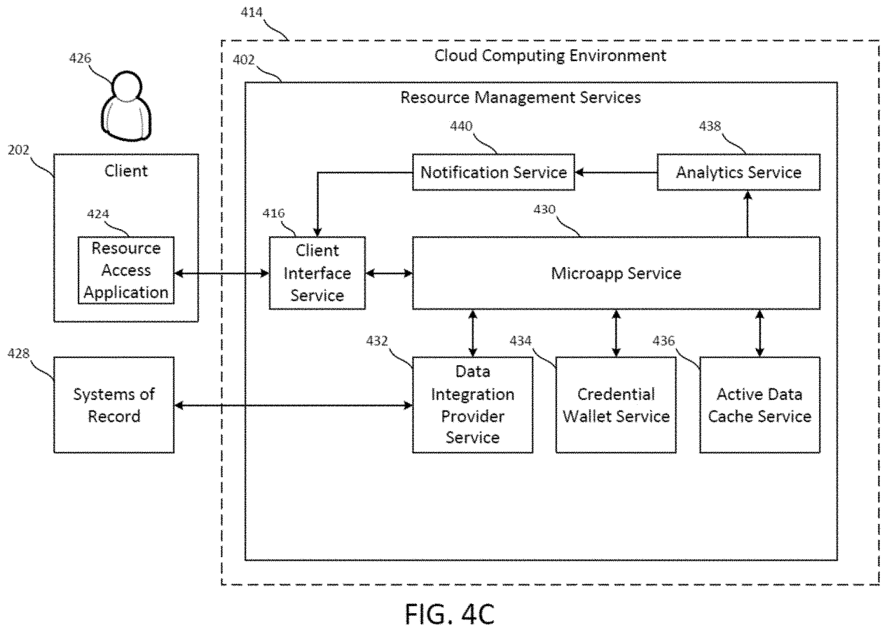

FIG. 4A is a block diagram of an illustrative system 400 in which one or more resource management services 402 may manage and streamline access by one or more clients 202 to one or more resource feeds 406 (via one or more gateway services 408) and/or one or more software-as-a-service (SaaS) applications 410. In particular, resource management service(s) 402 may employ an identity provider 412 to authenticate the identity of a user of a client 202 and, following authentication, identify one of more resources the user is authorized to access. In response to the user selecting one of the identified resources, resource management service(s) 402 may send appropriate access credentials to the requesting client 202, and the requesting client 202 may then use those credentials to access the selected resource. For resource feed(s) 406, client 202 may use the supplied credentials to access the selected resource via gateway service 408. For SaaS application(s) 410, client 202 may use the credentials to access the selected application directly.

Client(s) 202 may be any type of computing devices capable of accessing resource feed(s) 406 and/or SaaS application(s) 410, and may, for example, include a variety of desktop or laptop computers, smartphones, tablets, etc. Resource feed(s) 406 may include any of numerous resource types and may be provided from any of numerous locations. In some embodiments, for example, resource feed(s) 406 may include one or more systems or services for providing virtual applications and/or desktops to client(s) 202, one or more file repositories and/or file sharing systems, one or more secure browser services, one or more access control services for SaaS applications 410, one or more management services for local applications on client(s) 202, one or more internet enabled devices or sensors, etc. Each of resource management service(s) 402, resource feed(s) 406, gateway service(s) 408, SaaS application(s) 410, and identity provider 412 may be located within an on-premises data center of an organization for which system 400 is deployed, within one or more cloud computing environments, or elsewhere.

FIG. 4B is a block diagram showing an illustrative implementation of system 400 shown in FIG. 4A in which various resource management services 402 as well as gateway service 408 are located within a cloud computing environment 414. The cloud computing environment may, for example, include Microsoft Azure Cloud, Amazon Web Services, Google Cloud, or IBM Cloud.

For any of illustrated components (other than client 202) that are not based within cloud computing environment 414, cloud connectors (not shown in FIG. 4B) may be used to interface those components with cloud computing environment 414. Such cloud connectors may, for example, run on Windows Server instances hosted in resource locations and may create a reverse proxy to route traffic between the site(s) and cloud computing environment 414. In the illustrated example, the cloud-based resource management services 402 include a client interface service 416, an identity service 418, a resource feed service 420, and a single sign-on service 422. As shown, in some embodiments, client 202 may use a resource access application 424 to communicate with client interface service 416 as well as to present a user interface on client 202 that a user 426 can operate to access resource feed(s) 406 and/or SaaS application(s) 410. Resource access application 424 may either be installed on client 202 or may be executed by client interface service 416 (or elsewhere in system 400) and accessed using a web browser (not shown in FIG. 4B) on client 202.

As explained in more detail below, in some embodiments, resource access application 424 and associated components may provide user 426 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When resource access application 424 is launched or otherwise accessed by user 426, client interface service 416 may send a sign-on request to identity service 418. In some embodiments, identity provider 412 may be located on the premises of the organization for which system 400 is deployed. Identity provider 412 may, for example, correspond to an on-premises Windows Active Directory. In such embodiments, identity provider 412 may be connected to the cloud-based identity service 418 using a cloud connector (not shown in FIG. 4B), as described above. Upon receiving a sign-on request, identity service 418 may cause resource access application 424 (via client interface service 416) to prompt user 426 for the user's authentication credentials (e.g., username and password). Upon receiving the user's authentication credentials, client interface service 416 may pass the credentials along to identity service 418, and identity service 418 may, in turn, forward them to identity provider 412 for authentication, for example, by comparing them against an Active Directory domain. Once identity service 418 receives confirmation from identity provider 412 that the user's identity has been properly authenticated, client interface service 416 may send a request to resource feed service 420 for a list of subscribed resources for user 426.

In other embodiments (not illustrated in FIG. 4B), identity provider 412 may be a cloud-based identity service, such as a Microsoft Azure Active Directory. In such embodiments, upon receiving a sign-on request from client interface service 416, identity service 418 may, via client interface service 416, cause client 202 to be redirected to the cloud-based identity service to complete an authentication process. The cloud-based identity service may then cause client 202 to prompt user 426 to enter the user's authentication credentials. Upon determining the user's identity has been properly authenticated, the cloud-based identity service may send a message to resource access application 424 indicating the authentication attempt was successful, and resource access application 424 may then inform client interface service 416 of the successfully authentication. Once identity service 418 receives confirmation from client interface service 416 that the user's identity has been properly authenticated, client interface service 416 may send a request to resource feed service 420 for a list of subscribed resources for user 426.

For each configured resource feed, resource feed service 420 may request an identity token from single sign-on service 422. Resource feed service 420 may then pass the feed-specific identity tokens it receives to the points of authentication for the respective resource feeds 406. Each resource feed 406 may then respond with a list of resources configured for the respective identity. Resource feed service 420 may then aggregate all items from the different feeds and forward them to client interface service 416, which may cause resource access application 424 to present a list of available resources on a user interface of client 202. The list of available resources may, for example, be presented on the user interface of client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on client 202, and/or one or more SaaS applications 410 to which user 426 has subscribed. The lists of local applications and SaaS applications 410 may, for example, be supplied by resource feeds 406 for respective services that manage which such applications are to be made available to user 426 via resource access application 424. Examples of SaaS applications 410 that may be managed and accessed as described herein include Microsoft Office 365 applications, SAP SaaS applications, Workday applications, etc.

For resources other than local applications and SaaS application(s) 410, upon user 426 selecting one of the listed available resources, resource access application 424 may cause client interface service 416 to forward a request for the specified resource to resource feed service 420. In response to receiving such a request, resource feed service 420 may request an identity token for the corresponding feed from single sign-on service 422. Resource feed service 420 may then pass the identity token received from single sign-on service 422 to client interface service 416 where a launch ticket for the resource may be generated and sent to resource access application 424. Upon receiving the launch ticket, resource access application 424 may initiate a secure session to gateway service 408 and present the launch ticket. When gateway service 408 is presented with the launch ticket, it may initiate a secure session to the appropriate resource feed and present the identity token to that feed to seamlessly authenticate user 426. Once the session initializes, client 202 may proceed to access the selected resource.

When user 426 selects a local application, resource access application 424 may cause the selected local application to launch on client 202. When user 426 selects SaaS application 410, resource access application 424 may cause client interface service 416 request a one-time uniform resource locator (URL) from gateway service 408 as well a preferred browser for use in accessing SaaS application 410. After gateway service 408 returns the one-time URL and identifies the preferred browser, client interface service 416 may pass that information along to resource access application 424. Client 202 may then launch the identified browser and initiate a connection to gateway service 408. Gateway service 408 may then request an assertion from single sign-on service 422. Upon receiving the assertion, gateway service 408 may cause the identified browser on client 202 to be redirected to the logon page for identified SaaS application 410 and present the assertion. The SaaS may then contact gateway service 408 to validate the assertion and authenticate user 426. Once the user has been authenticated, communication may occur directly between the identified browser and the selected SaaS application 410, thus allowing user 426 to use client 202 to access the selected SaaS application 410.

In some embodiments, the preferred browser identified by gateway service 408 may be a specialized browser embedded in resource access application 424 (when the resource application is installed on client 202) or provided by one of the resource feeds 406 (when resource access application 424 is located remotely), e.g., via a secure browser service. In such embodiments, SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have client interface service 416 send the link to a secure browser service, which may start a new virtual browser session with client 202, and thus allow the user to access the potentially harmful linked content in a safe environment.

In some embodiments, in addition to or in lieu of providing user 426 with a list of resources that are available to be accessed individually, as described above, user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify user 426 of something that requires the user's attention (e.g., approval of an expense report, new course available for registration, etc.).

FIG. 4C is a block diagram similar to that shown in FIG. 4B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 4C may enable the provision of a streamlined resource activity feed and/or notification process for client 202. In the example shown, in addition to client interface service 416 discussed above, the illustrated services include a microapp service 430, a data integration provider service 432, a credential wallet service 434, an active data cache service 436, an analytics service 438, and a notification service 440. In various embodiments, the services shown in FIG. 4C may be employed either in addition to or instead of the different services shown in FIG. 4B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within resource access application 424 without having to launch the native application. The system shown in FIG. 4C may, for example, aggregate relevant notifications, tasks, and insights, and thereby give user 426 a dynamic productivity tool. In some embodiments, the resource activity feed may be intelligently populated by utilizing machine learning and artificial intelligence (AI) algorithms. Further, in some implementations, microapps may be configured within cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 4C, systems of record 428 may represent the applications and/or other resources resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. Resource management services 402, and in particular data integration provider service 432, may, for example, support REST API, JSON, OData-JSON, and 6ML. As explained in more detail below, data integration provider service 432 may also write back to the systems of record, for example, using OAuth2 or a service account.

In some embodiments, microapp service 430 may be a single-tenant service responsible for creating the microapps. Microapp service 430 may send raw events, pulled from systems of record 428, to analytics service 438 for processing. The microapp service may, for example, periodically pull active data from systems of record 428.

In some embodiments, active data cache service 436 may be single-tenant and may store all configuration information and microapp data. It may, for example, utilize a per-tenant database encryption key and per-tenant database credentials.

In some embodiments, credential wallet service 434 may store encrypted service credentials for systems of record 428 and user OAuth2 tokens.

In some embodiments, data integration provider service 432 may interact with systems of record 428 to decrypt end-user credentials and write back actions to systems of record 428 under the identity of the end-user. The write-back actions may, for example, utilize a user's actual account to ensure all actions performed are compliant with data policies of the application or other resource being interacted with.

In some embodiments, analytics service 438 may process the raw events received from microapps service 430 to create targeted scored notifications and send such notifications to notification service 440.

Finally, in some embodiments, notification service 440 may process any notifications it receives from analytics service 438. In some implementations, notification service 440 may store the notifications in a database to be later served in a notification feed. In other embodiments, notification service 440 may additionally or alternatively send the notifications out immediately to client 202 as a push notification to user 426.

In some embodiments, a process for synchronizing with systems of record 428 and generating notifications may operate as follows. Microapp service 430 may retrieve encrypted service account credentials for systems of record 428 from credential wallet service 434 and request a sync with data integration provider service 432. Data integration provider service 432 may then decrypt the service account credentials and use those credentials to retrieve data from systems of record 428. Data integration provider service 432 may then stream the retrieved data to microapp service 430. Microapp service 430 may store the received systems of record data in active data cache service 436 and also send raw events to analytics service 438. Analytics service 438 may create targeted scored notifications and send such notifications to notification service 440. Notification service 440 may store the notifications in a database to be later served in a notification feed and/or may send the notifications out immediately to client 202 as a push notification to user 426.

In some embodiments, a process for processing a user-initiated action via a microapp may operate as follows. Client 202 may receive data from microapp service 430 (via client interface service 416) to render information corresponding to the microapp. Microapp service 430 may receive data from active data cache service 436 to support that rendering. User 426 may invoke an action from the microapp, causing resource access application 424 to send that action to microapp service 430 (via client interface service 416). Microapp service 430 may then retrieve from credential wallet service 434 an encrypted Oauth2 token for the system of record for which the action is to be invoked and may send the action to data integration provider service 432 together with the encrypted Oath2 token. Data integration provider service 432 may then decrypt the Oath2 token and write the action to the appropriate system of record under the identity of user 426. Data integration provider service 432 may then read back changed data from the written-to system of record and send that changed data to microapp service 430. Microapp service 432 may then update active data cache service 436 with the updated data and cause a message to be sent to resource access application 424 (via client interface service 416) notifying user 426 that the action was successfully completed.

In some embodiments, in addition to or in lieu of the functionality described above, resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, resource management services 402 may enable virtual assistance functionality that allows users to remain productive and take quick actions. Users may, for example, interact with the “Virtual Assistant” and ask questions such as “What is Bob Smith's phone number?” or “What absences are pending my approval?” Resource management services 402 may, for example, parse these requests and respond because they are integrated with multiple systems on the backend. In some embodiments, users may be able to interact with the virtual assistance through either resource access application 424 or directly from another resource, such as Microsoft Teams. This feature may allow employees to work efficiently, stay organized, and deliver only the specific information they're looking for.

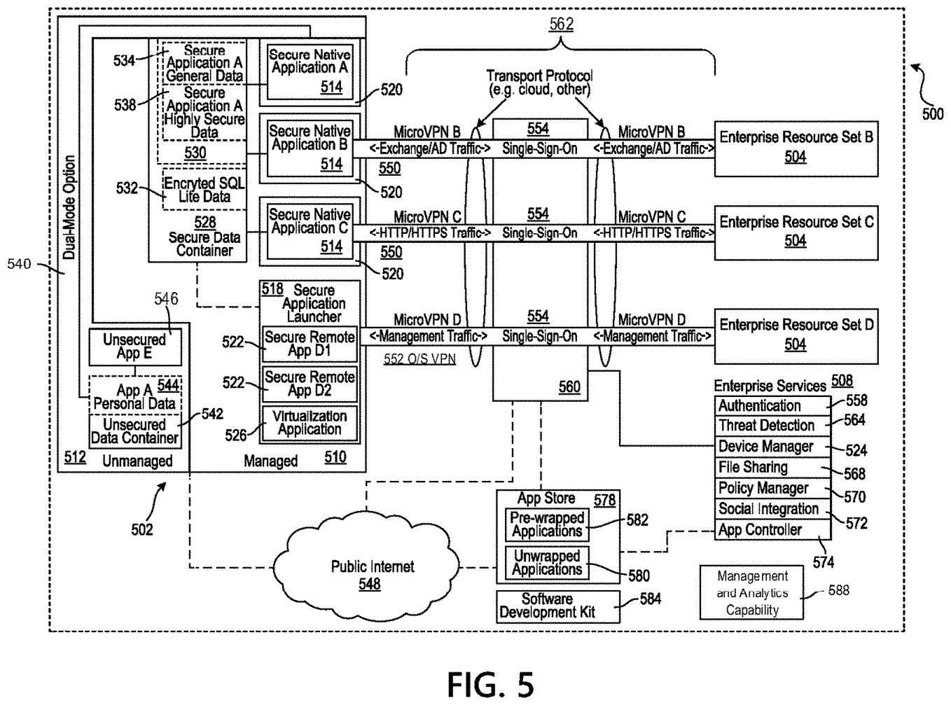

FIG. 5 depicts an illustrative enterprise mobility management system 500, in accordance with an embodiment of the present disclosure. For example, mobility management system 500 may be used in or to implement an enterprise mobile computing environment. In an example use case, mobility management system 500 enables a user of a mobile device 502 to both access enterprise or personal resources from mobile device 502 and use mobile device 502 for personal use. The user may access such enterprise resources 504 or enterprise services 508 using a mobile device 502 that is purchased by the user or a mobile device 502 that is provided by the enterprise to the user. The user may utilize mobile device 502 for business use only or for business and personal use. Mobile device 502 may run an iOS operating system, an Android operating system, or the like. The enterprise may choose to implement policies to manage mobile device 502. The policies may be implemented through a firewall or gateway in such a way that mobile device 502 may be identified, secured, or security verified, and provided selective or full access to the enterprise resources (e.g., 504 and 508). The policies may be mobile device management policies, mobile application management policies, mobile data management policies, or some combination of mobile device, application, and data management policies. A mobile device 502 that is managed through the application of mobile device management policies may be referred to as an enrolled device.

In some embodiments, the operating system of mobile device 502 may be separated into a managed partition 510 and an unmanaged partition 512. Managed partition 510 may have policies applied to it to secure the applications running on and data stored in managed partition 510. The applications running on managed partition 510 may be secure applications. In other embodiments, these applications may execute in accordance with a set of one or more policy files received separate from the application, and which define one or more security parameters, features, resource restrictions, and/or other access controls that are enforced by the mobile device management system when that application is executing on mobile device 502.

By operating in accordance with their respective policy file(s), each application may be allowed or restricted from communications with one or more other applications and/or resources, thereby creating a virtual partition. Thus, as used herein, a partition may refer to a physically partitioned portion of memory (physical partition), a logically partitioned portion of memory (logical partition), and/or a virtual partition created as a result of enforcement of one or more policies and/or policy files across multiple applications as described herein (virtual partition). Stated differently, by enforcing policies on managed applications, those applications may be restricted to only be able to communicate with other managed applications and trusted enterprise resources, thereby creating a virtual partition that is not accessible by unmanaged applications and devices.

The secure applications may be email applications, web browsing applications, software-as-a-service (SaaS) access applications, Windows Application access applications, and the like. The secure applications may be secure native applications 514, secure remote applications 522 executed by a secure application launcher 518, virtualization applications 526 executed by a secure application launcher 518, and the like. Secure native applications 514 may be wrapped by a secure application wrapper 520.

Secure application wrapper 520 may include integrated policies that are executed on mobile device 502 when secure native application 514 is executed on mobile device 502. Secure application wrapper 520 may include metadata that points secure native application 514 running on mobile device 502 to the resources hosted at the enterprise (e.g., 504 and 508) that secure native application 514 may require to complete the task requested upon execution of secure native application 514. Secure remote applications 522 executed by a secure application launcher 518 may be executed within secure application launcher 518. Virtualization applications 526 executed by secure application launcher 518 may utilize resources on mobile device 502, at enterprise resources 504, and the like.

The resources used on mobile device 502 by virtualization applications 526 executed by secure application launcher 518 may include user interaction resources, processing resources, and the like. The user interaction resources may be used to collect and transmit keyboard input, mouse input, camera input, tactile input, audio input, visual input, gesture input, and the like. The processing resources may be used to present a user interface, process data received from enterprise resources 504, and the like. The resources used at enterprise resources 504 by virtualization applications 526 executed by secure application launcher 518 may include user interface generation resources, processing resources, and the like. The user interface generation resources may be used to assemble a user interface, modify a user interface, refresh a user interface, and the like. The processing resources may be used to create information, read information, update information, delete information, and the like.

For example, virtualization application 526 may record user interactions associated with a graphical user interface (GUI) and communicate them to a server application where the server application uses the user interaction data as an input to the application operating on the server. In such an arrangement, an enterprise may elect to maintain the application on the server side as well as data, files, etc. associated with the application. While an enterprise may elect to “mobilize” some applications in accordance with the principles herein by securing them for deployment on mobile device 502, this arrangement may also be elected for certain applications.

For example, while some applications may be secured for use on mobile device 502, others might not be prepared or appropriate for deployment on mobile device 502 so the enterprise may elect to provide the mobile user access to the unprepared applications through virtualization techniques. As another example, the enterprise may have large complex applications with large and complex data sets (e.g., material resource planning applications) where it would be very difficult, or otherwise undesirable, to customize the application for mobile device 502 so the enterprise may elect to provide access to the application through virtualization techniques. As yet another example, the enterprise may have an application that maintains highly secured data (e.g., human resources data, customer data, engineering data) that may be deemed by the enterprise as too sensitive for even the secured mobile environment so the enterprise may elect to use virtualization techniques to permit mobile access to such applications and data.

An enterprise may elect to provide both fully secured and fully functional applications on mobile device 502 as well as virtualization application 526 to allow access to applications that are deemed more properly operated on the server side. In an embodiment, virtualization application 526 may store some data, files, etc. on mobile device 502 in one of the secure storage locations. An enterprise, for example, may elect to allow certain information to be stored on mobile device 502 while not permitting other information.

In connection with virtualization application 526, as described herein, mobile device 502 may have virtualization application 526 that is designed to present GUIs and then record user interactions with the GUI. Virtualization application 526 may communicate the user interactions to the server side to be used by the server side application as user interactions with the application. In response, the application on the server side may transmit back to mobile device 502 a new GUI. For example, the new GUI may be a static page, a dynamic page, an animation, or the like, thereby providing access to remotely located resources.

Secure applications 514 may access data stored in a secure data container 528 in managed partition 510 of mobile device 502. The data secured in the secure data container may be accessed by secure native applications 514, secure remote applications 522 executed by secure application launcher 518, virtualization applications 526 executed by secure application launcher 518, and the like. The data stored in secure data container 528 may include files, databases, and the like. The data stored in secure data container 528 may include data restricted to a specific secure application 530, shared among secure applications 532, and the like.

Data restricted to a secure application may include secure general data 534 and highly secure data 538. Secure general data may use a strong form of encryption such as Advanced Encryption Standard (AES) 128-bit encryption or the like, while highly secure data 538 may use a very strong form of encryption such as AES 256-bit encryption. Data stored in secure data container 528 may be deleted from mobile device 502 upon receipt of a command from device manager 524. The secure applications (e.g., 514, 522, and 526) may have a dual-mode option 540.

Dual mode option 540 may present the user with an option to operate the secured application in an unsecured or unmanaged mode. In an unsecured or unmanaged mode, the secure applications may access data stored in an unsecured data container 542 on unmanaged partition 512 of mobile device 502. The data stored in an unsecured data container may be personal data 544. The data stored in unsecured data container 542 may also be accessed by unsecured applications 546 that are running on unmanaged partition 512 of mobile device 502. The data stored in unsecured data container 542 may remain on mobile device 502 when the data stored in secure data container 528 is deleted from mobile device 502.

An enterprise may want to delete from mobile device 502 selected or all data, files, and/or applications owned, licensed or controlled by the enterprise (enterprise data) while leaving or otherwise preserving personal data, files, and/or applications owned, licensed or controlled by the user (personal data). This operation may be referred to as a selective wipe. With the enterprise and personal data arranged in accordance to the aspects described herein, an enterprise may perform a selective wipe.

Mobile device 502 may connect to enterprise resources 504 and enterprise services 508 at an enterprise, to public Internet 548, and the like. Mobile device 502 may connect to enterprise resources 504 and enterprise services 508 through virtual private network connections. The virtual private network connections, also referred to as microVPN or application-specific VPN, may be specific to particular applications (as illustrated by microVPNs 550, particular devices, particular secured areas on the mobile device (as illustrated by O/S VPN 552), and the like. For example, each of the wrapped applications in the secured area of mobile device 502 may access enterprise resources through an application specific VPN such that access to the VPN would be granted based on attributes associated with the application, possibly in conjunction with user or device attribute information.

The virtual private network connections may carry Microsoft Exchange traffic, Microsoft Active Directory traffic, HyperText Transfer Protocol (HTTP) traffic, HyperText Transfer Protocol Secure (HTTPS) traffic, application management traffic, and the like. The virtual private network connections may support and enable single-sign-on authentication processes 554. The single-sign-on processes may allow a user to provide a single set of authentication credentials, which are then verified by an authentication service 558. Authentication service 558 may then grant to the user access to multiple enterprise resources 504, without requiring the user to provide authentication credentials to each individual enterprise resource 504.

The virtual private network connections may be established and managed by an access gateway 560. Access gateway 560 may include performance enhancement features that manage, accelerate, and improve the delivery of enterprise resources 504 to mobile device 502. Access gateway 560 may also re-route traffic from mobile device 502 to public Internet 548, enabling mobile device 502 to access publicly available and unsecured applications that run on public Internet 548. Mobile device 502 may connect to the access gateway via a transport network 562. Transport network 562 may use one or more transport protocols and may be a wired network, wireless network, cloud network, local area network, metropolitan area network, wide area network, public network, private network, and the like.

Enterprise resources 504 may include email servers, file sharing servers, SaaS applications, Web application servers, Windows application servers, and the like. Email servers may include Exchange servers, Lotus Notes servers, and the like. File sharing servers may include ShareFile servers, and the like. SaaS applications may include Salesforce, and the like. Windows application servers may include any application server that is built to provide applications that are intended to run on a local Windows operating system, and the like. Enterprise resources 504 may be premise-based resources, cloud-based resources, and the like. Enterprise resources 504 may be accessed by mobile device 502 directly or through access gateway 560. Enterprise resources 504 may be accessed by mobile device 502 via transport network 562.

Enterprise services 508 may include authentication services 558, threat detection services 564, device manager services 524, file sharing services 568, policy manager services 570, social integration services 572, application controller services 574, and the like. Authentication services 558 may include user authentication services, device authentication services, application authentication services, data authentication services, and the like. Authentication services 558 may use certificates. The certificates may be stored on mobile device 502, by enterprise resources 504, and the like. The certificates stored on mobile device 502 may be stored in an encrypted location on mobile device 502, the certificate may be temporarily stored on mobile device 502 for use at the time of authentication, and the like. Threat detection services 564 may include intrusion detection services, unauthorized access attempt detection services, and the like. Unauthorized access attempt detection services may include unauthorized attempts to access devices, applications, data, and the like. Device management services 524 may include configuration, provisioning, security, support, monitoring, reporting, and decommissioning services. File sharing services 568 may include file management services, file storage services, file collaboration services, and the like. Policy manager services 570 may include device policy manager services, application policy manager services, data policy manager services, and the like. Social integration services 572 may include contact integration services, collaboration services, integration with social networks such as Facebook, Twitter, and LinkedIn, and the like. Application controller services 574 may include management services, provisioning services, deployment services, assignment services, revocation services, wrapping services, and the like.

Mobility management system 500 may include an application store 578. Application store 578 may include unwrapped applications 580, pre-wrapped applications 582, and the like. Applications may be populated in application store 578 from application controller 574. Application store 578 may be accessed by mobile device 502 through access gateway 560, through public Internet 548, or the like. Application store 578 may be provided with an intuitive and easy to use user interface.

A software development kit 584 may provide a user the capability to secure applications selected by the user by wrapping the application as described previously in this description. An application that has been wrapped using software development kit 584 may then be made available to mobile device 502 by populating it in application store 578 using application controller 574.

Mobility management system 500 may include a management and analytics capability 588. Management and analytics capability 588 may provide information related to how resources are used, how often resources are used, and the like. Resources may include devices, applications, data, and the like. How resources are used may include which devices download which applications, which applications access which data, and the like. How often resources are used may include how often an application has been downloaded, how many times a specific set of data has been accessed by an application, and the like.

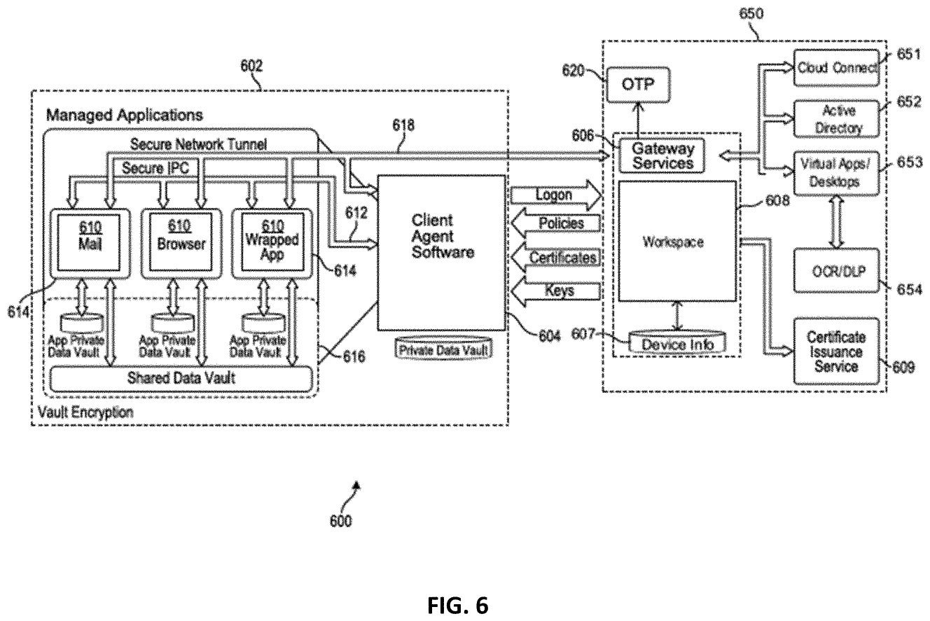

FIG. 6 depicts an illustrative enterprise computing device management system 600, in accordance with an embodiment of the present disclosure. For example, computing device management system 600 may be used in or to implement an enterprise computing environment. Some of the components of mobility management system 500 described above with reference to FIG. 5 have been omitted for the sake of simplicity. The architecture of system 600 depicted in FIG. 6 is similar in many respects to the architecture of mobility management system 500 described above with reference to FIG. 5 and may include additional features not mentioned above.

As can be seen, the left side of FIG. 6 represents an enrolled computing device 602 with a client agent 604, which interacts with a gateway server 606 (which includes Access Gateway and application controller functionality) to access various virtual apps/desktops 653 and other resources, such as an active directory (AD) 652 resource, as shown on the right side of FIG. 6. Computing device 602 may be a mobile computing device, such as mobile device 502, or a stationary (e.g., non-mobile) computing device. Examples of mobile computing devices include a smartphone, tablet, laptop computer, notebook computer, smart watch, and personal digital assistant (PDA), to name a few examples. Examples of stationary computing devices include a desktop computer, workstation, and a smart TV, to name several examples. The services and components on the right side of FIG. 6 may collectively be referred to as a sensitive content management system 650, the functions of which are described in more detail below.

Client agent 604 may act as the UI (user interface) intermediary for virtual apps/desktops 653 hosted by sensitive content management system 650, which may be accessed using the High-Definition User Experience (HDX)/ICA display remoting protocol. Client agent 604 may also support the installation and management of native applications on computing device 602, such as native WINDOWS, macOS, iOS, or ANDROID applications. For example, managed applications 610 (mail, browser, wrapped application) shown in FIG. 6 may be native applications that execute locally on computing device 602. Client agent 604 and application management framework of this architecture may act to provide policy driven management capabilities and features such as connectivity and single sign-on (SSO) to enterprise resources/services (e.g., virtual apps/desktops 653, active directory 652). Client agent 604 may handle primary user authentication to the enterprise, normally to Access Gateway (AG) 606 with SSO to other gateway server components. Client agent 604 may obtain policies from gateway server 606 to control the behavior of managed applications 610 on computing device 602.

Secure InterProcess Communication (IPC) links 612 between native applications 610 and client agent 604 represent a management channel, which may allow a client agent to supply policies to be enforced by an application management framework 614 “wrapping” each application. IPC channel 612 may also allow client agent 604 to supply credential and authentication information that enables connectivity and SSO to enterprise resources (e.g., virtual apps/desktops 653, active directory 652). In addition, IPC channel 612 may allow application management framework 614 to invoke user interface functions implemented by client agent 604, such as online and offline authentication.

Communications between client agent 604 and gateway server 606 may be essentially an extension of the management channel from application management framework 614 wrapping each native managed application 610. Application management framework 614 may request policy information from client agent 604, which in turn may request it from gateway server 606. Application management framework 614 may request authentication, and client agent 604 may log into the gateway services part of gateway server 606 (also known as NETSCALER ACCESS GATEWAY). Client agent 604 may also call supporting services on gateway server 606, which may produce input material to derive encryption keys for local data vaults 616 or may provide client certificates which may enable direct authentication to PKI protected resources, as more fully explained below.

In more detail, application management framework 614 “wraps” each managed application 610. This may be incorporated via an explicit build operation or step, or via a post-build processing operation or step. Application management framework 614 may “pair” with client agent 604 on first launch of an application 610 to initialize secure IPC channel 612 and obtain the policy for that application. Application management framework 614 may enforce relevant portions of the policy that apply locally, such as the client agent login dependencies and some of the containment policies that restrict how local OS services may be used, or how they may interact with managed application 610.

Application management framework 614 may use services provided by client agent 604 over secure IPC channel 612 to facilitate authentication and internal network access. Key management for the private and shared data vaults 616 (containers) may be also managed by appropriate interactions between managed applications 610 and client agent 604. Vaults 616 may be available only after online authentication or may be made available after offline authentication if allowed by policy. First use of vaults 616 may require online authentication, and offline access may be limited to at most the policy refresh period before online authentication is again required.

Network access to internal resources may occur directly from individual managed applications 610 through Access Gateway 606. Application management framework 614 may be responsible for orchestrating the network access on behalf of each managed application 610. Client agent 604 may facilitate these network connections by providing suitable time limited secondary credentials obtained following online authentication. Multiple modes of network connection may be used, such as reverse web proxy connections and end-to-end VPN-style tunnels 618.

Mail and Browser managed applications 610 may have special status and may make use of facilities that might not be generally available to arbitrary wrapped applications. For example, Mail application 610 may use a special background network access mechanism that allows it to access an exchange server (not shown) over an extended period of time without requiring a full AG logon. Browser application 610 may use multiple private data vaults 616 to segregate different kinds of data.

This architecture may support the incorporation of various other security features. For example, gateway server 606 (including its gateway services) in some cases may not need to validate active directory (AD) passwords. It can be left to the discretion of an enterprise whether an AD password may be used as an authentication factor for some users in some situations. Different authentication methods may be used if a user is online or offline (i.e., connected or not connected to a network).

Step up authentication is a feature wherein gateway server 606 may identify managed native applications 610 that are allowed to have access to highly classified data requiring strong authentication, and ensure that access to these applications is only permitted after performing appropriate authentication, even if this means a re-authentication is required by the user after a prior weaker level of login.

Another security feature of this solution is the encryption of data vaults 616 (containers) on computing device 602. Vaults 616 may be encrypted so that all on-device data including files, databases, and configurations are protected. For on-line vaults, the keys may be stored on a server (e.g., gateway server 606), and for off-line vaults, a local copy of the keys may be protected by a user password or biometric validation. If or when data is stored locally on computing device 602 in secure container 616, a minimum of AES 256 encryption algorithm may be utilized, although other suitable encryption algorithms may be used.

Other secure container features may also be implemented. For example, a logging feature may be included, wherein security events happening inside managed application 610 may be logged and reported to the backend. Data wiping may be supported, such as if or when managed application 610 detects tampering, associated encryption keys may be written over with random data, leaving no hint on the file system that user data was destroyed. Screenshot protection may be another feature, where an application may prevent any data from being stored in screenshots. For example, the key window's hidden property may be set to YES. This may cause whatever content is currently displayed on the screen to be hidden, resulting in a blank screenshot where any content would normally reside.

Local data transfer may be prevented, such as by preventing any data from being locally transferred outside the application container, e.g., by copying it or sending it to an external application. A keyboard cache feature may operate to disable the autocorrect functionality for sensitive text fields. SSL certificate validation may be operable so the application specifically validates the server SSL certificate instead of it being stored in the keychain. An encryption key generation feature may be used such that the key used to encrypt data on computing device 602 is generated using a passphrase or biometric data supplied by the user (if offline access is required). It may be XORed with another key randomly generated and stored on the server side if offline access is not required. Key Derivation functions may operate such that keys generated from the user password use KDFs (key derivation functions, notably Password-Based Key Derivation Function 2 (PBKDF2)) rather than creating a cryptographic hash of it. The latter makes a key susceptible to brute force or dictionary attacks.

Further, one or more initialization vectors may be used in encryption methods. An initialization vector can cause multiple copies of the same encrypted data to yield different cipher text output, preventing both replay and cryptanalytic attacks. This can also prevent an attacker from decrypting any data even with a stolen encryption key. Further, authentication then decryption may be used, wherein application data is decrypted only after the user has authenticated within the application. Another feature may relate to sensitive data in memory, which may be kept in memory (and not in disk) only when it's needed. For example, login credentials may be wiped from memory after login, and encryption keys and other data inside objective-C instance variables are not stored, as they may be easily referenced. Instead, memory may be manually allocated for these.

An inactivity timeout may be implemented, wherein after a policy-defined period of inactivity, a user session is terminated.

Data leakage from application management framework 614 may be prevented in other ways. For example, if or when a managed application 610 is put in the background, the memory may be cleared after a predetermined (configurable) time period. When backgrounded, a snapshot may be taken of the last displayed screen of the application to fasten the foregrounding process. The screenshot may contain confidential data and hence should be cleared.

Another security feature may relate to the use of an OTP (one time password) 620 without the use of AD 652 password for access to one or more applications. In some cases, some users do not know (or are not permitted to know) their AD password, so these users may authenticate using OTP 620 such as by using a hardware OTP system like SecurID (OTPs may be provided by different vendors also, such as Entrust or Gemalto). In some cases, after a user authenticates with a user ID, a text may be sent to the user with an OTP 620. In some cases, this may be implemented only for online use, with a prompt being a single field.

An offline password may be implemented for offline authentication for those managed applications 610 for which offline use is permitted via enterprise policy. For example, an enterprise may want StoreFront to be accessed in this manner. In this case, client agent 604 may require the user to set a custom offline password and the AD password is not used. Gateway server 606 may provide policies to control and enforce password standards with respect to the minimum length, character class composition, and age of passwords, such as described by the standard Windows Server password complexity requirements, although these requirements may be modified.

Another feature may relate to the enablement of a client side certificate for certain applications 610 as secondary credentials (for the purpose of accessing PKI protected web resources via the application management framework micro VPN feature). For example, managed application 610 may utilize such a certificate. In this case, certificate-based authentication using ActiveSync protocol may be supported, wherein a certificate from client agent 604 may be retrieved by gateway server 606 and used in a keychain. Each managed application 610 may have one associated client certificate, identified by a label that is defined in gateway server 606.

Gateway server 606 may interact with an enterprise special purpose web service to support the issuance of client certificates to allow relevant managed applications to authenticate to internal PKI protected resources.

Client agent 604 and application management framework 614 may be enhanced to support obtaining and using client certificates for authentication to internal PKI protected network resources. More than one certificate may be supported, such as to match various levels of security and/or separation requirements. The certificates may be used by Mail and Browser managed applications 610, and ultimately by arbitrary wrapped applications 610 (provided those applications use web service style communication patterns where it is reasonable for the application management framework to mediate HTTPS requests).

Application management client certificate support on iOS may rely on importing a public-key cryptography standards (PKCS) 12 BLOB (Binary Large Object) into the iOS keychain in each managed application 610 for each period of use. Application management framework client certificate support may use a HTTPS implementation with private in-memory key storage. The client certificate may not be present in the iOS keychain and may not be persisted except potentially in “online-only” data value that is strongly protected.

Mutual SSL or TLS may also be implemented to provide additional security by requiring that computing device 602 is authenticated to the enterprise, and vice versa. Virtual smart cards for authentication to gateway server 606 may also be implemented.

Another feature may relate to application container locking and wiping, which may automatically occur upon jailbreak or rooting detections, and occur as a pushed command from administration console, and may include a remote wipe functionality even when managed application 610 is not running.

A multi-site architecture or configuration of enterprise application store and an application controller may be supported that allows users to be serviced from one of several different locations in case of failure.

In some cases, managed applications 610 may be allowed to access a certificate and private key via an API (for example, OpenSSL). Trusted managed applications 610 of an enterprise may be allowed to perform specific Public Key operations with an application's client certificate and private key. Various use cases may be identified and treated accordingly, such as if or when an application behaves like a browser and no certificate access is required, if or when an application reads a certificate for “who am I,” if or when an application uses the certificate to build a secure session token, and if or when an application uses private keys for digital signing of important data (e.g., transaction log) or for temporary data encryption.

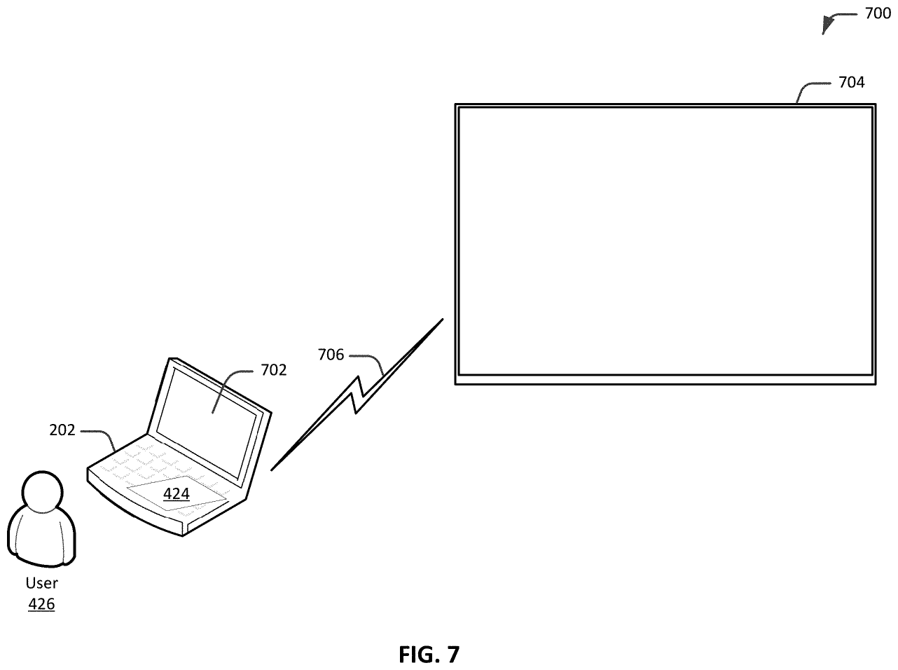

FIG. 7 is a diagram illustrating an example environment 700 in which data loss protection may be implemented, in accordance with an embodiment of the present disclosure. As can be seen, environment 700 may include client 202 having a display 702 (also referred to herein as a primary display 702). Client 202 may be communicatively coupled to a secondary display 704 via a connection 706. As described previously, client 202 can be any type of device, such as a laptop computer, a desktop computer, a handheld computer, a tablet computer, a cellular telephone, a smartphone, or any other computing device having an attached display 702. Secondary display 704 may be in a variety of forms such as, for example, a liquid crystal display (LCD), a cathode ray tube (CRT), plasma display device, a light-emitting diode (LED) display, or other type of display panel. In some cases, secondary display 704 may have one or more display attributes that are different from the display attributes of primary display 702. Non-limiting examples of display attributes include, for example, screen size, aspect ratio, resolution, and width and/or height of view port or display. Connection 706 may be over a wired communication link (e.g., local area network, universal serial bus (USB), etc.) and/or a wireless communication link (e.g., radio frequency (RF), Bluetooth, NFC, Wi-Fi, etc.), including combinations thereof. While only one secondary display 704 is depicted in FIG. 7 for purposes of clarity, it will be appreciated that other embodiments can include additional secondary displays, such as two, three, four, or a larger number of secondary displays.

In an example use case and embodiment, as shown in FIG. 7, user 426 may use an application, such as resource access application 424, running on client 202 to access content generated by another application, such as SaaS application 410 (shown in FIG. 4B). For example, the accessed content may be the contents of a web page generated by SaaS application 410, and resource access application 424 (e.g., a browser application) may display the accessed content within an application window. Resource access application 424 may launch on primary display 702 and initially render the application window on primary display 702. In some cases, resource access application 424 may launch on secondary display 704 and initially render the application window on secondary display 704. In any case, subsequent to the launch of the resource access application 424, user 426 can relocate the application window between primary display 702 and secondary display 704. For example, user 426 can click and drag the application window that is being displayed on primary display 702 onto secondary display 704, causing the application window to display on secondary display 704. Conversely, user 426 can click and drag the application window that is being displayed on secondary display 704 onto primary display 702, causing the application window to display on primary display 702. In some cases, the application window being displayed on secondary display 704 may no longer be displayed on secondary display 704 by and/or in response to user input, for example, an input that closes the application window.

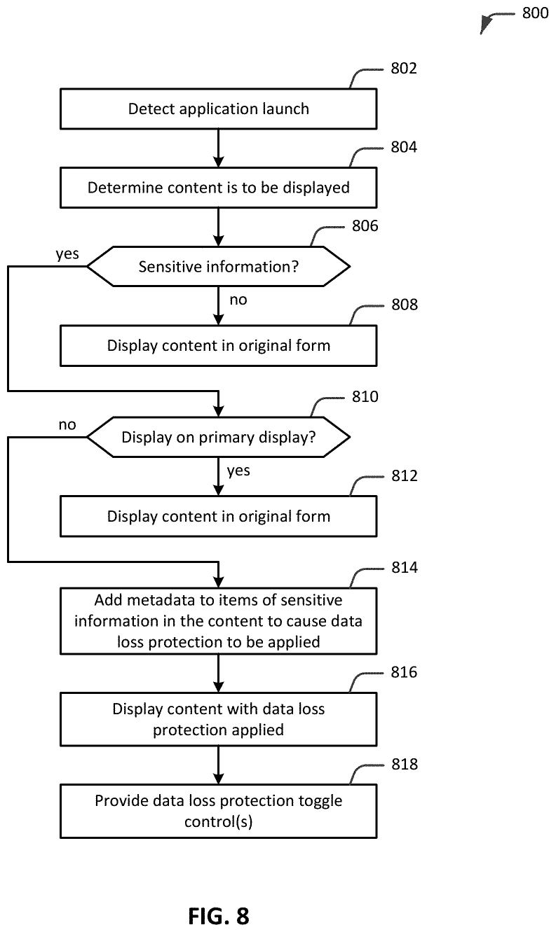

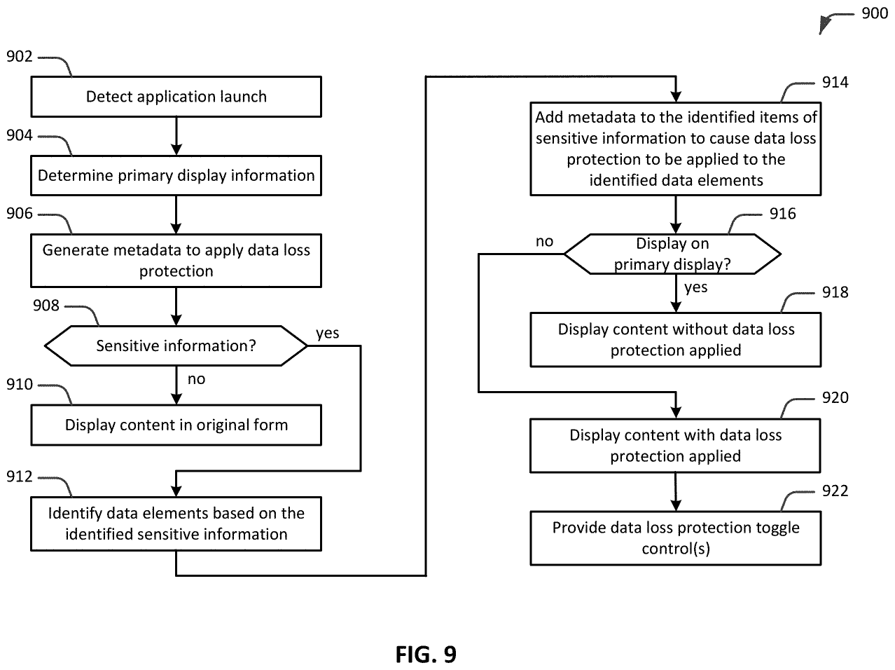

Resource access application 424 may determine whether the accessed content is to be displayed on primary display 702 or on secondary display 704. Techniques that can be used to determine whether the content is displayed on the primary or secondary display are further described below at least in conjunction with FIGS. 8 and 9. In response to a determination that the accessed content is to be displayed on primary display 702 resource access application 424 can cause the accessed content to be displayed in its original form within the application window on primary display 702 without any modification to the way the accessed content is shown. In response to a determination that the accessed content is to be displayed on secondary display 704, resource access application 424 can apply data loss protection to items of sensitive information contained in the accessed content, and cause the accessed content to be displayed with data loss protection within the application window on secondary display 704. Displaying the accessed content with data loss protection causes the items of sensitive information contained in the content to be displayed in modified or obfuscated form such that the items of sensitive information in the accessed content are hidden from view.

In some embodiments, resource access application 424 may provide a toggle control with the display of the accessed content on secondary display 704. The provided toggle control may be a user interface control element that is configured to enable or not enable (disable) the application of data loss protection to the accessed content. In one such embodiment, resource access application 424 can provide the toggle control as a control element within or as part of an application window, such as a browser window, showing the accessed content. So, in the case where data loss protection is enabled and items of sensitive information contained in the accessed content are hidden from view, a user can use the toggle control to disable the data loss protection to cause the accessed content to be displayed in its original form on secondary display 704, in which case the items of sensitive information contained in the accessed content is viewable and not hidden from view while the accessed content is shown on secondary display 704. Alternatively, in the case where data loss protection is disabled and the items of sensitive information contained in the accessed content is viewable, the user can use the toggle control to enable the data loss protection to cause the accessed content to be displayed in modified from on secondary display 704, in which case the items of sensitive information contained in the accessed content are hidden from view and not viewable while the accessed content is shown on secondary display 704.

In an example implementation, resource access application 424 may utilize a server side data loss protection service, such as an optical character recognition/data loss prevention (OCR/DLP) service 654 of sensitive content management system 650 of FIG. 6, to determine whether the accessed content contains any items of sensitive information. The accessed content may be in a text-based format (e.g., textual data) or an image-based format (e.g., an image of the content). In the case of an image, OCR/DLP service 654 may use optical character recognition (OCR) to convert the image of the content to textual data. It will be appreciated that other methods/techniques of text extraction may also be used (e.g., textual data may be embedded in the content and extracted). In any case, OCR/DLP service 654 may scan the accessed content to identify items of sensitive information contained in the accessed content.

For example, OCR/DLP service 654 may scan the textual data for certain keywords or phrases, and/or search the textual data using regular expressions, for patterns of characters to identify items of sensitive information contained in the accessed content being accessed by user 426 using resource access application 424. Non-limiting examples of sensitive information include any data that could potentially be used to identify a particular individual (e.g., a full name, Social Security number, driver's license number, bank account number, passport number, and email address), financial information regarding an individual/organization, and information deemed confidential by the individual/organization (e.g., contracts, sales quotes, customer contact information, phone numbers, personal information about employees, and employee compensation information). Other pattern recognition techniques may be used to identify items of sensitive information.

OCR/DLP service 654 may determine the locations of the identified items of sensitive information within the accessed content. For example, in the case of textual content, an OCR process and/or a text extraction process of OCR/DLP service 654 may tag recognized words or characters in the content with location data indicating absolute or relative (e.g., with respect to other display elements) display position data, such as coordinates. Then, for identified items of sensitive information, OCR/DLP service 654 can provide to resource access application 424, for example, a starting and ending character location which contains the item of sensitive information. In the case of an image, for identified items of sensitive information, OCR/DLP service 654 can provide to resource access application 424, for example, a location of a bounding rectangle (e.g., coordinates of the four corners of the bounding rectangle) that delineates or defines the bounds (e.g., boundary) of the identified item of sensitive information.

In some embodiments, an application server, such as virtual apps/desktops 653 of FIG. 6, may utilize OCR/DLP service 654 of sensitive content management system 650 to determine whether the accessed content (e.g., content to be delivered to user 426 via resource access application 424) contains any items of sensitive information. For example, this may be the case where client 202 is a computing device enrolled to interact with gateway server 606 (which includes Access Gateway and application controller functionality) to access various virtual apps/desktops 653 and other resources, such as an active directory (AD) 652 resource, as shown on the right side of FIG. 6. In other embodiments, gateway server 606 may utilize OCR/DLP service 654 of sensitive content management system 650 to determine whether the accessed content contains any items of sensitive information. In other implementations, resource access application 424 may utilize a DLP service provided on the client side, such as, for example, on client 202, to determine whether the accessed content contains sensitive information.

With continued reference to FIG. 7, in some embodiments, resource access application 424 can add metadata to the items of sensitive information contained in the accessed content to apply data loss protection to the sensitive information. The metadata added to an item of sensitive information may cause a change in a display attribute of the item of sensitive information to cause the sensitive information to be displayed in modified form such that the item of sensitive information is hidden from view or otherwise unrecognizable and/or unreadable. For example, in the case where the item of sensitive information includes text, the metadata added to the item of sensitive information may define an adjustment of the size of the text (e.g., font size) to a different size (e.g., smaller size), an adjustment of the color of the text to a less visible color, an adjustment of the background color to effectively hide or otherwise make the text less visible, an adjustment of the opacity to control the transparency of the text, an adjustment of the alpha blending to blend the foreground text with the background, and/or an adjustment of the zoom percentage of the area surrounding the sensitive text to a smaller zoom percentage. In the case where the item of sensitive information includes an image (e.g., an icon), the metadata added to the item of sensitive information may define an adjustment of the size of the image to a smaller size, an adjustment of the color of the image to a less visible color, and/or an adjustment of the zoom percentage of the area surrounding the sensitive image to a smaller zoom percentage. In any case, resource access application 424 can add metadata to the items of sensitive information contained in the accessed content to decrease the visibility of the sensitive information contained in the accessed content. In some embodiments, the metadata can be Cascading Style Sheets (CSS) styles that are applied to elements of the Directory Object Model (DOM) corresponding to the sensitive information, wherein the CSS styles are defined in a stylesheet.

FIG. 8 is a flow diagram of an example process 800 for applying data loss protection during display on a secondary display, in accordance with an embodiment of the present disclosure. Example process 800, and example processes 900 and 1000 further described below, may be implemented or used within a computing environment or system such as those disclosed above at least with respect to FIG. 1, FIG. 2, FIG. 3, FIGS. 4A-4C, FIG. 5, FIG. 6 and/or FIG. 7. For example, in some embodiments, the operations, functions, or actions illustrated in example process 800, and example processes 900 and 1000 further described below, may be stored as computer-executable instructions in a computer-readable medium, such as volatile memory 122 and/or non-volatile memory 128 of computing device 100 of FIG. 2 (e.g., computer-readable medium of client machines 102 of FIG. 1, client machines 102a-102n of FIG. 3 and/or clients 202 of FIGS. 4A-4C). For example, the operations, functions, or actions described in the respective blocks of example process 800, and example processes 900 and 1000 further described below, may be implemented by applications 116 and/or data 117 of computing device 100.

With reference to process 800 of FIG. 8, at 802, client 202 may detect a launch of a client application on client 202. For example, a user, such as user 426 (FIG. 4C), may launch a client application, such as resource access application 424, on client 202 to access content. In this example and embodiment, it is assumed that resource access application 424 is a native application, such as the native CITRIX WORKSPACE app, that can interact with an underlying operating system on client 202, for example, using operating system-level APIs. In some cases, the native CITRIX WORKSPACE app may include a browser application, such as the Citrix browser, that can interact with the underlying operating system on client 202. In any case, the operating system on client 202 may detect and recognize devices and peripherals, such as primary display 702 and secondary display 704, attached and/or communicatively coupled to client 202. For example, the operating system may utilize a system-level API, such as MonitorFromWindow or MonitorFromPoint, to identify a display monitor handle for a given window and then use GetMonitorinfo to obtain attributes such as a size of the monitor. The monitor information structure (e.g., Monitor Info structure) returned from the API may include fields (e.g., rcWork, rcMonitor, etc.) whose values can be used to determine whether the monitor is a primary display or not a primary display. Note that alternate implementations may utilize other system-level APIs and different order or logic to determine whether the window of an application is on a primary display.

The operating system on client 202 may also maintain metadata regarding the display characteristics (e.g., color depth, display depth, refresh rate, etc.) of the displays coupled to client 202 (e.g., primary display 702 and secondary display 704), the particular display or displays that the applications, such as resource access application 424, are launched or otherwise executing on, contents that are to be rendered on the displays, layout of the application windows on the displays, etc.

At 804, resource access application 424 may determine that content is to be displayed on one of the displays of client 202. For example, user 426 may use resource access application 424 to access content from a network resource, such as workspace component 608 of content management system 650 of FIG. 6. The operating system can then send to resource access application 424 a system-level message (e.g., WM_PAINT message) to allow resource access application 424 to paint or update the window content.

At 806, resource access application 424 may check to determine whether the content contains sensitive information. For example, in cases where resource access application 424 accesses content from workspace component 608 of content management system 650, gateway server 606 may utilize an optical character recognition/data loss prevention (OCR/DLP) service 654 of content management system 650 to determine whether the content to be delivered to user 426 (e.g., the content the user wants to access) contains any items of sensitive content (sensitive information). In other cases, the network resource or resource access application 424 may utilize a server side or client side data loss protection service similar to OCR/DLP service 654 to determine whether the content to be delivered to user 426 contains any items of sensitive information. In any case, the data loss protection service may deliver or otherwise provide the content to resource access application 424 in its original form along with associated metadata that provides information regarding any identified items of sensitive information contained in the content. For example, the metadata may provide the location details (e.g., coordinates, bounding rectangles, position details, etc.) for individual items of sensitive information contained in the content. The metadata may be included in a data structure.

If a determination is made that the content does not contain sensitive information, then, at 808, resource access application 424 may cause the content to be displayed in its original form without data loss protection. Note that the content may be displayed on primary display 702, secondary display 704, and/or another display or displays attached and/or communicatively coupled to client 202. For example, resource access application 424 can utilize the underlying operating system on client 202 to display the content within an application window or windows rendered on a display or displays communicatively coupled to client 202. Here, since the content does not include sensitive information, the content can be displayed as is without modification on the display or displays communicatively coupled to client 202 without risk of leakage or compromise to sensitive information.

If a determination is made that the content contains sensitive information, then, at 810, resource access application 424 may check to determine whether the content is to display on primary display 702. For example, resource access application 424 can determine from the underlying operating system on client 202 the display the application window of resource access application 424 is being rendered on.

If a determination is made that the content is to display on primary display 702, then, at 812, resource access application 424 may cause the content, including the items of sensitive information contained in the content, to be displayed in original form without data loss protection on primary display 702. As explained above, resource access application 424 can utilize the underlying operating system on client 202 to display the content within an application window on primary display 702. Note that, since the content is displayed on primary display 702, it is assumed that there is less risk of leakage or compromise to sensitive information as compared to when the content is displayed on a display other than primary display 702. As such, the content is displayed in original form without applying data loss protection to the items of sensitive information contained in the content.

If a determination is made that the content is to display on a display other than primary display 702, such as, for example, secondary display 704, then, at 814, resource access application 424 may add metadata to the individual items of sensitive information contained in the content to apply data loss protection to the sensitive information. The added metadata may cause the items of sensitive information to display in modified form such that the individual items of sensitive information are hidden from view or otherwise unrecognizable. As described previously, the metadata added to the individual items of sensitive information may define an adjustment of the size of the text (e.g., font size) to a different size (e.g., smaller size), an adjustment of the color of the text to a less visible color, an adjustment of the background color to effectively hide or otherwise make the text less visible, an adjustment of the opacity to control the transparency of the text, an adjustment of the alpha blending to blend the foreground text with the background, an adjustment of the zoom percentage of the area surrounding the sensitive text to a smaller zoom percentage, an adjustment of the size of the image to a smaller size, an adjustment of the color of the image to a less visible color, and/or an adjustment of the zoom percentage of the area surrounding the sensitive image to a smaller zoom percentage.

In an alternative implementation, resource access application 424 may send the display attributes (e.g., screen size, aspect ratio, resolution, etc.) of secondary display 704 to a backend system, such as resource management service 402 or gateway service 408. For example, resource access application 424 may send the display attributes to the backend system when resource access application 424 connects to the backend system. In such implementations, the backend system can add the metadata to the individual items of sensitive information contained in the content to apply data loss protection to the sensitive information, and send or otherwise provide the content with the added metadata to resource access application 424.

At 816, resource access application 424 may cause the content to be displayed with data loss protection on the display other than primary display 702. Display of the content with data loss protection causes the items of sensitive information contained in the content to be displayed in modified form as defined by the metadata added to the individual items of sensitive information. As explained above, resource access application 424 can utilize the underlying operating system on client 202 to display the content within the application window on the display other than primary display 702. Note that, since the content is displayed on a display other than primary display 702, it is assumed that there is increased risk of leakage or compromise to sensitive information as compared to when the content is displayed on primary display 702, and the sensitive information contained in the content is displayed in modified form based on the added metadata such that the items of sensitive information in the content are hidden from view.

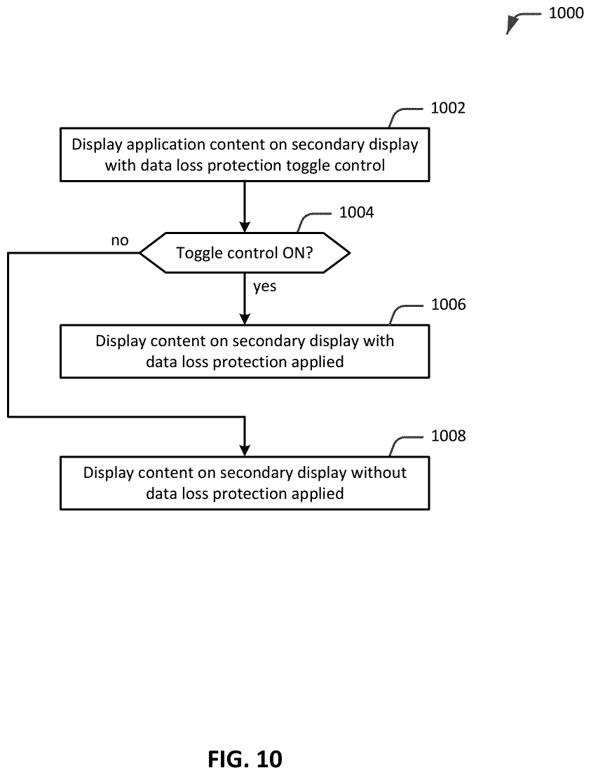

At 818, resource access application 424 may provide a toggle control with the display of the content on the display other than primary display 702. In an embodiment, resource access application 424 can provide the toggle control as a control element within or as part of the application window showing the content on the display. As will be further described below at least in conjunction with FIG. 10, the toggle control may be configured to enable or not enable (disable) the application of data loss protection to the items of sensitive information contained in the content.

Resource access application 424 may repeat the operations of 804-818 as necessary to display the content on a display or displays of client 202 for viewing by user 426.

FIG. 9 is a flow diagram of an example process 900 for applying data loss protection during display on a secondary display, in accordance with another embodiment of the present disclosure. At 902, client 202 may detect a launch of a client application on client 202. For example, a user, such as user 426, may launch a URL associated with a web application, such as CITRIX WORKSPACE (backend), in a browser on client 202 to connect to Workspace. This may cause a client application, such as resource access application 424, to load on client 202 to access content provided by an application. In this example and embodiment, it is assumed that resource access application 424 is a client application that may not have the ability to directly interact with an underlying operating system on client 202. In such implementations, the local browser can run JavaScript or extensions and use Directory Object Model (DOM) methods to query display attributes and setup metadata as disclosed herein. For example, when launched, resource access application 424 can load an agent, such as JavaScript, extensions (e.g., Chrome extensions), and/or other suitable event handlers/listeners, to access the HTML DOM structure for resource access application 424.

At 904, resource access application 424 may determine attributes (e.g., screen dimensions) of a primary display, such as primary display 702, of client 202. In some cases, resource access application 424 may launch on primary display 702. In other cases, resource access application 424 may launch on secondary display 704. In any case, resource access application 424 may have knowledge of the dimensions of primary display 702 of client 202. Note that, in cases where resource access application 424 launches on primary display 702, resource access application 424 is aware of the attributes of primary display 702, such as the screen dimensions. In cases where resource access application 424 launches on a display other than primary display 702, such as secondary display 704, resource access application 424 may obtain the dimensions of primary display 702 from a backend system, such as resource management service 402 or gateway service 408. For example, resource access application 424 may obtain the screen dimensions when user 426 uses resource access application 424 to log onto the backend system. Having knowledge of the screen dimensions of primary display 702, resource access application 424 can use the loaded agent to dynamically generate media screen queries based on the dimensions of primary display 702.

Browsers support @media rules that can be used in media queries to apply different styles for different media types/devices. Media queries can be used to check for specific screen rules such as, by way of example and not a limitation, width/height of the device, resolution, etc. By way of an example, a media screen query can be defined that changes a background color of an element to a specified color (e.g., black) when the browser window does not exceed (i.e., is less than or equal to) a specified dimension.

At 906, resource access application 424 may generate metadata to apply the data loss protection. In an implementation, the agent loaded inside resource access application 424 can generate media screen queries to apply data loss protection based on the dimensions of primary display 702. In this case, the metadata may be in the form of media screen queries that define display attributes that are applied to HTML elements based on whether the HTML elements are displayed on a display having the same dimensions as primary display 702. The display attributes may be defined using style sheets and classes.

For example, the agent can generate a media screen query that is based on display dimensions not matching the dimensions of primary display 702. The agent can also generate a class that is controlled via the generated media screen query (the class is applied when the media screen query computes to true). The class may specify that that the font color and the background color are to be the same. In other examples, the class may change the font size, color, opacity, zoom percentage, and/or look-and-feel of the HTML element.

At 908, resource access application 424 may check to determine whether the content contains sensitive information. For example, a DLP service, such as OCR/DLP service 654, may be used to determine whether the content contains any items of sensitive information. In cases where the content contains sensitive information, the DLP service may generate and/or provide metadata that identifies the items of sensitive information contained in the content.

If a determination is made that the content does not contain sensitive information, then, at 910, resource access application 424 may cause the content to be displayed in its original form without data loss protection.

Otherwise, if a determination is made that the content contains sensitive information, then, at 912, resource access application 424 may identify the data elements in the content that correspond to the identified items of sensitive information (e.g., the HTML elements that correspond the sensitive information). Such data elements may be identified using the metadata (e.g., location of the elements corresponding to the sensitive information) provided by the DLP service.

For example, in the case of a HTML web page with content <html><head><title>Title</title></head><body><div class=“divclass” id=“divid”>My phone number is 123456789</div></body></html>, the sensitive content may be the phone number, 123456789. In this example case, the DLP service can provide metadata such as starting location=98 which is the first numeric in the phone number, end location=107 which is the last numeric in the phone number, length=10 which is the length of the sensitive content, and sensitive data classification metadata such as a type or category of Personally Identifiable Information (PII), PHONE_NUMBER, etc. Using the DOM, and from the starting location, end location, and length metadata, resource access application 424 can determine that the web element that contains this sensitive information is <div class=“divclass” id=“divid”>. As will be appreciated in light of this disclosure, other alternative implementations are also possible based on the type of metadata output or otherwise provided by the DL service and processing such metadata in the context of DOM and HTML content to identify an appropriate element or elements that contain sensitive information.

At 914, the generated metadata may be added to the identified items of sensitive information to cause data loss protection to be applied to these data elements. For instance, the agent may add the class attributes and associated media screen query generated at 906 to the identified HTML elements in the content. Not that, even though the class attributes are added to the elements, the class attributes will only be applied when the media screen query computes to true (the media screen query check returns true). In an alternative implementation, resource access application 424 may send the display attributes (e.g., screen size, aspect ratio, resolution, etc.) of secondary display 704 to a backend system, such as resource management service 402 or gateway service 408. For example, resource access application 424 may send the display attributes to the backend system when resource access application 424 connects to the backend system. In such implementations, the backend system can add the metadata (media screen queries, features, CSS styles and/or attributes, etc.) to the individual items of sensitive information contained in the content to apply data loss protection to the sensitive information, and send or otherwise provide the content with the added metadata to resource access application 424.

At 916, resource access application 424 may check to determine whether the content is to display on primary display 702. If a determination is made that the content is to display on primary display 702, then, at 918, resource access application 424 may cause the content, including the items of sensitive information contained in the content, to be displayed in original form without data loss protection on primary display 702. Note that, in this instance, the class attributes added to the elements corresponding to the items of sensitive information at 914 are not applied since the media screen query computes to false because the content is to display on primary display 702.

If a determination is made that the content is to display on a display other than primary display 702, such as, for example, secondary display 704, then, at 920, resource access application 424 may cause the content to be displayed with data loss protection on the display other than primary display 702. Note that, in this instance, the class attributes added to the elements corresponding to the items of sensitive information at 914 are applied since the media screen query computes to true because the content is to display on a display other than primary display 702. Applying the class attributes causes the items of sensitive information to display in modified form as defined by the class attributes.

At 922, resource access application 424 may optionally provide a toggle control with the display of the content on the display other than primary display 702. In an embodiment, resource access application 424 can provide the toggle control as a control element within or as part of a browser window showing the content on the display. As will be further described below at least in conjunction with FIG. 10, the toggle control may be configured to enable or not enable (disable) the application of data loss protection to the items of sensitive information contained in the content.

Resource access application 424 may repeat the operations of 908-922 as necessary to display the content on a display or displays of client 202 for viewing by user 426.

FIG. 10 is a flow diagram of an example process 1000 for applying data loss protection based on a toggle control, in accordance with an embodiment of the present disclosure. As described previously, a client application, such as resource access application 424, may provide the toggle control with the display of content on a secondary display, such as secondary display 704. The toggle control may be implemented as a UI control that a user can click or otherwise interface with to toggle the application of the data loss protection.

With reference to process 1000 of FIG. 10, at 1002, resource access application 424 may display content on secondary display 704 of client 202 with data loss protection applied to the items of sensitive information contained in the content. With the display of content on secondary display 704, resource access application 424 may provide a toggle control for use to toggle the application of the data loss protection. For example, user 426 may use the provided toggle control to enable or disable the application of the data loss protection.

At 1004, resource access application 424 may check to determine whether the toggle control is ON. In an implementation, resource access application 424 may apply the data loss protection to the items of sensitive information as a default when the content is first displayed on secondary display 704. In this case, the items of sensitive information are displayed on secondary display 704 in modified form such that the individual items of sensitive information are hidden from view and resource access application 424 may provide the toggle control for use to control the application of the data loss protection. User 426 can then use the toggle control to disable the data loss protection, which causes the items of sensitive information to be displayed in original form without data loss protection on primary display 702.

If a determination is made that the toggle control is ON, then, at 1006, resource access application 424 may cause the content to be displayed with data loss protection on secondary display 704. Display of the content with data loss protection causes the items of sensitive information contained in the content to be displayed in modified form as defined by the metadata added to the individual items of sensitive information.

If a determination is made that the toggle control is not ON (i.e., the toggle control is OFF), then, at 1008, resource access application 424 may cause the content to be displayed in its original form without data loss protection on secondary display 704. For instance, in cases where the metadata is in the form of class attributes and associated media screen queries, the class attributes added to the elements corresponding to the items of sensitive information may be updated, disabled, and/or removed. For example, the class attributes may be updated to cause the items of sensitive information to be displayed in a form that is not hidden from view. Additionally or alternatively, the class attributes that were added to the elements may be removed, thus causing the items of sensitive information to be displayed in original form without data loss protection. In any case, when the toggle control is OFF, the items of sensitive information contained in the content are displayed on secondary display 704 in a form that is visible and not in obfuscated form.

Resource access application 424 may repeat the operations of 1004-1008 as necessary to display the content on secondary display 704 of client 202 in accordance with the state of the provided toggle control.

In some embodiments, resource access application 424 can provide a toggle control for individual items of sensitive information displayed on secondary display 704. This allows a user to individually control the application of the data loss protection on the items of sensitive information. For example, the user can use the respective toggle controls to cause data loss protection to be applied to a first item of sensitive information and cause the data loss protection to not be applied to a second item of sensitive information.

### FURTHER EXAMPLE EMBODIMENTS

The following examples pertain to further embodiments, from which numerous permutations and configurations will be apparent.

Example 1 includes a method including: identifying sensitive information within content displayable with use of a display of a computing device; adding metadata to the sensitive information, the metadata to cause a change in an appearance of the content before display of that content on a secondary display, the secondary display being separate from the display of the computing device; and, responsive to a determination to display the content on the secondary display, modifying the content based on the added metadata so that sensitive information is hidden from view while the content is shown on the secondary display; and providing on the secondary display the modified content so as to prevent the sensitive information from being viewable by users not authorized to view such sensitive information.

Example 2 includes the subject matter of Example 1, further comprising, responsive to the determination to display the content on the secondary display, providing a toggle control configured to enable or disable modifying of the content based on the added metadata.

Example 3 includes the subject matter of Example 2, further comprising, responsive to disabling of the modifying of the content based on the added metadata, providing on the secondary display the content without modification based on the added metadata.

Example 4 includes the subject matter of Example 3, further comprising, responsive to enabling of the modifying of the content based on the added metadata subsequent to the disabling of the modifying of the content based on the added metadata, providing on the secondary display the content with the modification based on the added metadata so as to prevent the sensitive information from being viewable by users not authorized to view such sensitive information.

Example 5 includes the subject matter of any of Examples 1 through 4, wherein the metadata added to the sensitive information defines an adjustment of at least one item of sensitive information from a first font size to a second font size, the second font size being different than the first font size.

Example 6 includes the subject matter of any of Examples 1 through 5, wherein the metadata added to the sensitive information defines an adjustment of at least one item of sensitive information from a first font color to a second font color, the second font color being different than the first font color.

Example 7 includes the subject matter of any of Examples 1 through 6, wherein the metadata added to the sensitive information defines an adjustment of at least one item of sensitive information from a first font background color to a second font background color, the second font background color being different than the first font background color.

Example 8 includes the subject matter of any of Examples 1 through 7, wherein the metadata added to the sensitive information defines an adjustment of at least one item of sensitive information from a first zoom percentage to a second zoom percentage, the second zoom percentage being different than the first zoom percentage.

Example 9 includes the subject matter of any of Examples 1 through 8, wherein modifying the content based on the added metadata causes at least one item of sensitive information to be displayed in obfuscated form while the content is shown on the secondary display.

Example 10 includes the subject matter of any of Examples 1 through 9, wherein the secondary display has a screen attribute that is different than a screen attribute of the display of the computing device.

Example 11 includes the subject matter of any of Examples 1 through 10, further comprising, responsive to a determination that the content provided on the secondary display is to be displayed on the display of the computing device, providing on the display of the computing device the content without modification based on the added metadata.

Example 12 includes the subject matter of any of Examples 1 through 11, wherein determination to display the content on the secondary display is based on a screen attribute of the secondary display.

Example 13 includes the subject matter of any of Examples 1 through 11, wherein determination to display the content on the secondary display is based on a query to an operating system (OS) running on the computing device.

Example 14 includes a system including a memory and one or more processors in communication with the memory and configured to: identify sensitive information within content displayable with use of a display of a computing device; add metadata to the sensitive information, the metadata to cause a change in an appearance of the content before display of that content on a secondary display, the secondary display being separate from the display of the computing device; and, responsive to a determination to display the content on the secondary display, modify the content based on the added metadata so that sensitive information is hidden from view while the content is shown on the secondary display; and provide on the secondary display the modified content so as to prevent the sensitive information from being viewable by users not authorized to view such sensitive information.

Example 15 includes the subject matter of Example 14, wherein the one or more processors are further configured to, responsive to the determination to display the content on the secondary display, provide a toggle control configured to enable or disable modification of the content based on the added metadata.

Example 16 includes the subject matter of Example 15, wherein the one or more processors are further configured to, responsive to disablement of the modification of the content based on the added metadata, provide on the secondary display the content without modification based on the added metadata.

Example 17 includes the subject matter of Example 16, wherein the one or more processors are further configured to, responsive to enablement of the modification of the content based on the added metadata subsequent to the disablement of the modification of the content based on the added metadata, provide on the secondary display the content with the modification based on the added metadata so as to prevent the sensitive information from being viewable by users not authorized to view such sensitive information.

Example 18 includes the subject matter of any of Examples 14 through 17, wherein the metadata added to the sensitive information defines an adjustment of at least one item of sensitive information from a first font size to a second font size, the second font size being different than the first font size.

Example 19 includes the subject matter of any of Examples 14 through 18, wherein the metadata added to the sensitive information defines an adjustment of at least one item of sensitive information from a first font color to a second font color, the second font color being different than the first font color.

Example 20 includes the subject matter of any of Examples 14 through 19, wherein the metadata added to the sensitive information defines an adjustment of at least one item of sensitive information from a first font background color to a second font background color, the second font background color being different than the first font background color.

Example 21 includes the subject matter of any of Examples 14 through 20, wherein the metadata added to the sensitive information defines an adjustment of at least one item of sensitive information from a first zoom percentage to a second zoom percentage, the second zoom percentage being different than the first zoom percentage.

Example 22 includes the subject matter of any of Examples 14 through 21, wherein to modify the content based on the added metadata causes at least one item of sensitive information to be displayed in obfuscated form while the content is shown on the secondary display.

Example 23 includes the subject matter of any of Examples 14 through 22, wherein the secondary display has a screen attribute that is different than a screen attribute of the display of the computing device.

Example 24 includes the subject matter of any of Examples 14 through 23, wherein the one or more processors are further configured to, responsive to a determination that the content provided on the secondary display is to be displayed on the display of the computing device, provide on the display of the computing device the content without modification based on the added metadata.

Example 25 includes the subject matter of any of Examples 14 through 24, wherein determination to display the content on the secondary display is based on a screen attribute of the secondary display

Example 26 includes the subject matter of any of Examples 14 through 24, wherein determination to display the content on the secondary display is based on a query to an operating system (OS) running on the computing device.

Example 27 includes a method including: identifying sensitive information within content to be displayed on a display of a computing device; and, responsive to a determination to display the content on a secondary display distinct from a display of the computing device, modifying the content so that sensitive information is hidden from view while the content is shown on the secondary display; and displaying on the secondary display the modified content so as to prevent the sensitive information from being viewable.

Example 28 includes the subject matter of Example 27, wherein determination to display the content on the secondary display is based on a screen attribute of the secondary display.

Example 29 includes the subject matter of Example 27, wherein determination to display the content on the secondary display is based on a query to an operating system (OS) running on the computing device.

Example 30 includes the subject matter of any of Examples 27 through 29, wherein modifying the content includes adjusting at least one item of sensitive information from a first font color to a second font color, the second font color being different than the first font color.

Example 31 includes the subject matter of any of Examples 27 through 30, wherein modifying the content includes adjusting at least one item of sensitive information from a first font background color to a second font background color, the second font background color being different than the first font background color.

Example 32 includes the subject matter of any of Examples 27 through 31, wherein modifying the content includes adjusting at least one item of sensitive information from a first zoom percentage to a second zoom percentage, the second zoom percentage being different than the first zoom percentage.

Example 33 includes the subject matter of any of Examples 27 through 32, wherein modifying the content includes adjusting at least one item of sensitive information from a first font size to a second font size, the second font size being different than the first font size.

Example 34 includes the subject matter of any of Examples 27 through 33, wherein modifying the content causes at least one item of sensitive information to be displayed in obfuscated form while the content is shown on the secondary display.

Example 35 includes the subject matter of any of Examples 27 through 34, wherein the secondary display has a screen attribute that is different than a screen attribute of the display of the computing device.

Example 36 includes the subject matter of any of Examples 27 through 35, further comprising, responsive to a determination that the content displayed on the secondary display is to be displayed on the display of the computing device, displaying on the display of the computing device the content without modification of the content.

Example 37 includes the subject matter of any of Examples 27 through 36, further comprising, providing a toggle control for enabling or disabling modifying of the content.

Example 38 includes a system including a memory and one or more processors in communication with the memory and configured to: identify sensitive information within content to be displayed on a display of a computing device; and, responsive to a determination to display the content on a secondary display distinct from a display of the computing device, modify the content so that sensitive information is hidden from view while the content is shown on the secondary display; and display on the secondary display the modified content so as to prevent the sensitive information from being viewable.

Example 39 includes the subject matter of Example 38, wherein determination to display the content on the secondary display is based on a screen attribute of the secondary display.

Example 40 includes the subject matter of Example 38, wherein determination to display the content on the secondary display is based on a query to an operating system (OS) running on the computing device.

Example 41 includes the subject matter of any of Examples 39 and 40, wherein to modify the content includes an adjustment of at least one item of sensitive information from a first font color to a second font color, the second font color being different than the first font color.

Example 42 includes the subject matter of any of Examples 38 through 41, wherein to modify the content includes an adjustment of at least one item of sensitive information from a first font background color to a second font background color, the second font background color being different than the first font background color.

Example 43 includes the subject matter of any of Examples 38 through 42, wherein to modify the content includes an adjustment of at least one item of sensitive information from a first zoom percentage to a second zoom percentage, the second zoom percentage being different than the first zoom percentage.

Example 44 includes the subject matter of any of Examples 38 through 43, wherein to modify the content includes an adjustment of at least one item of sensitive information from a first font size to a second font size, the second font size being different than the first font size.

Example 45 includes the subject matter of any of Examples 38 through 44, wherein to modify the content causes at least one item of sensitive information to be displayed in obfuscated form while the content is shown on the secondary display.

Example 46 includes the subject matter of any of Examples 38 through 45, wherein the secondary display has a screen attribute that is different than a screen attribute of the display of the computing device.

Example 47 includes the subject matter of any of Examples 38 through 46, wherein the one or more processors are further configured to, responsive to a determination that the content displayed on the secondary display is to be displayed on the display of the computing device, display on the display of the computing device the content without modification of the content.

Example 48 includes the subject matter of any of Examples 38 through 46, wherein the one or more processors are further configured to provide a toggle control for enabling or disabling modifying of the content.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A method comprising:
identifying sensitive information within content displayable with use of a display of a computing device;
adding metadata to the sensitive information, the metadata to cause a change in an appearance of the content before display of that content on a secondary display, the secondary display being separate from the display of the computing device; and
responsive to a determination to display the content on the secondary display,
modifying the content based on the added metadata so that sensitive information is hidden from view while the content is shown on the secondary display; and
providing on the secondary display the modified content so as to prevent the sensitive information from being viewable by users not authorized to view such sensitive information.

2. The method of claim 1, further comprising, responsive to the determination to display the content on the secondary display, providing a toggle control configured to enable or disable modifying of the content based on the added metadata.

3. The method of claim 2, further comprising, responsive to disabling of the modifying of the content based on the added metadata, providing on the secondary display the content without modification based on the added metadata.

4. The method of claim 3, further comprising, responsive to enabling of the modifying of the content based on the added metadata subsequent to the disabling of the modifying of the content based on the added metadata, providing on the secondary display the content with the modification based on the added metadata so as to prevent the sensitive information from being viewable by users not authorized to view such sensitive information.

5. The method of claim 1, wherein the metadata added to the sensitive information defines an adjustment of at least one item of sensitive information from a first font size to a second font size, the second font size being different than the first font size.

6. The method of claim 1, wherein the metadata added to the sensitive information defines an adjustment of at least one item of sensitive information from a first font color to a second font color, the second font color being different than the first font color.

7. The method of claim 1, wherein the metadata added to the sensitive information defines an adjustment of at least one item of sensitive information from a first font background color to a second font background color, the second font background color being different than the first font background color.

8. The method of claim 1, wherein the metadata added to the sensitive information defines an adjustment of at least one item of sensitive information from a first zoom percentage to a second zoom percentage, the second zoom percentage being different than the first zoom percentage.

9. The method of claim 1, wherein modifying the content based on the added metadata causes at least one item of sensitive information to be displayed in obfuscated form while the content is shown on the secondary display.

10. The method of claim 1, wherein the secondary display has a screen attribute that is different than a screen attribute of the display of the computing device.

11. The method of claim 1, further comprising, responsive to a determination that the content provided on the secondary display is to be displayed on the display of the computing device, providing on the display of the computing device the content without modification based on the added metadata.

12. A computing device comprising:
a memory; and
one or more processors in communication with the memory and configured to,
identify sensitive information within content displayable with use of a display of a computing device;
add metadata to the sensitive information, the metadata to cause a change in an appearance of the content before display of that content on a secondary display, the secondary display being separate from the display of the computing device; and
responsive to a determination to display the content on the secondary display,
modify the content based on the added metadata so that sensitive information is hidden from view while the content is shown on the secondary display; and
provide on the secondary display the modified content so as to prevent the sensitive information from being viewable by users not authorized to view such sensitive information.

13. The computing device of claim 12, wherein the one or more processors are further configured to, responsive to the determination to display the content on the secondary display, provide a toggle control configured to enable or disable modification of the content based on the added metadata.

14. The computing device of claim 13, wherein the one or more processors are further configured to, responsive to disablement of the modification of the content based on the added metadata, provide on the secondary display the content without modification based on the added metadata.

15. The computing device of claim 14, wherein the one or more processors are further configured to, responsive to enablement of the modification of the content based on the added metadata subsequent to the disablement of the modification of the content based on the added metadata, provide on the secondary display the content with the modification based on the added metadata so as to prevent the sensitive information from being viewable by users not authorized to view such sensitive information.

16. The computing device of claim 12, wherein the metadata added to the sensitive information defines one of:
an adjustment of at least one item of sensitive information from a first font size to a second font size, the second font size being different than the first font size;
an adjustment of at least one item of sensitive information from a first font color to a second font color, the second font color being different than the first font color;
an adjustment of at least one item of sensitive information from a first font background color to a second font background color, the second font background color being different than the first font background color; or
an adjustment of at least one item of sensitive information from a first zoom percentage to a second zoom percentage, the second zoom percentage being different than the first zoom percentage.

17. The computing device of claim 12, wherein the one or more processors are further configured to, responsive to a determination that the content provided on the secondary display is to be displayed on the display of the computing device, provide on the display of the computing device the content without modification based on the added metadata.

18. A method comprising:
identifying sensitive information within content to be displayed on a display of a computing device; and
responsive to a determination to display the content on a secondary display distinct from a display of the computing device,
modifying the content so that sensitive information is hidden from view while the content is shown on the secondary display; and
displaying on the secondary display the modified content so as to prevent the sensitive information from being viewable.

19. The method of claim 18, further comprising providing a toggle control for enabling or disabling modifying of the content.

20. The method of claim 18, wherein determination to display the content on the secondary display is based on a query to an operating system (OS) running on the computing device.
